(19) United States
(12) Patent Application Publication
(10) Pub. No.: US 2013/0344802 A1
(43) Pub. Date: Dec. 26, 2013

(54) SYSTEM AND METHOD FOR MULTI-TIER AUTOMATIC TRANSIT SYSTEM UPDATING

(71) Applicants: Dave Gordon Armour, Bosque Farms, NM (US); John Stephen Newman, Boca Raton, FL (US); Mattew Cedroc Vogel, Clearfield, UT (US)

(72) Inventors: Dave Gordon Armour, Bosque Farms, NM (US); John Stephen Newman, Boca Raton, FL (US); Mattew Cedroc Vogel, Clearfield, UT (US)

(21) Appl. No.: 13/533,881

(22) Filed: Jun. 26, 2012

(51) Int. Cl. H04W 24/00

(52) U.S. Cl. CPC H04W 24/00
USPC 455/39

(57) ABSTRACT

Devices, systems and methods are provided for updating one or more components of a transit system. A wireless communications connection is established between each train in a transit system with at least one master control station. Each car in a train is communicatively connected using a train's consists and/or a local area network, which may include a wireless network. Positional information regarding each train may be communicated to the master control station and packages of information responsive to present or future scheduling, messaging, operating or other needs may be communicated to system components. Such packages may include, for example, scheduling updates and updated public address messages and may be designated for one or more terminals in one or more train cars, or otherwise. A master terminal may be configured to control intra-train communications and inter-train communications and positional reporting of a train to the master control station.

The various embodiments described herein generally relate to devices, systems and methods for providing up-to-date information of, for and to mass transit vehicle operators, system administrators, passengers, emergency responders and others.

### BACKGROUND

Often operators, system managers, passengers, emergency responders and others involved in the use, operation, maintenance, safety and related aspects of mass transit vehicles face a void of information regarding such mass transit vehicles. Information may be needed and desired for a variety of purposes, such as scheduling, maintenance, operation, troubleshooting, emergency response, and passenger updating. While various systems and other technologies have been developed which provide some schedule, location, messaging, and other information related services, existing systems often are not robust across an entire transit network. Such systems can be subject to black-outs and often are not up-to-date with the most recent information. The automatic updating of information is not provided thereby hindering the activities of central planners, operators, conductors, passengers and others. Further, when such systems are updateable, they often are not customizable in content, audience, timing or the like. As such robust, scalable and adaptable systems and methodologies for providing information relating to messaging, control, diagnostic, scheduling, location, emergency response and other aspects of multi-tier transit systems are needed.

For purposes of conciseness only, mass transit systems may contain multiple vehicles operating together (e.g., a train) or independently but cooperatively (e.g., a bus/train transit system). The embodiments discussed herein are directed to vehicles which typically operate with respect to a limited guide-way, often determined by one or more rails. Such vehicles are commonly referred to as a “train” or “trains.” While trains, as used in the conventional sense, are to be considered as being included in one or more of the embodiments discussed herein, “trains,” as used herein, is intended to generally include any type of vehicle that is utilized on a regular or repeat basis to provide transit services to one or more members of a given populace by a legal entity such as a public, private, governmental, quasi-governmental, or otherwise entity. Examples of vehicles included within this definition of “train(s)” additionally include any vehicle, regardless of size, shape or configuration, operating on roads, rails, water or other byways, such as busses, vans, motor coaches, ferries, boats, and any other vehicle intended for public transit use, such as bike share vehicles and the like. Examples of vehicles excluded from this definition of “trains” are private vehicles, such as cars, bikes, motorcycles, personal water craft and similar vehicles owned and operated by a private person for their own use and enjoyment. It is thus to be appreciated that the various embodiments discussed herein can be applied to any type of vehicle, and are not limited “trains”—as used in the traditional sense to refer to a vehicle that operates on one or more rails.

### SUMMARY

These and other limitations of existing apparatus, methods, and systems are overcome by the various embodiments described herein.

In at least one first embodiment, a system is provided for updating at least one train of a transit system. The system may include at least one train position determining device, configured to determine a position of a train having one or more cars and to output one or more train position signals. The system may also include at least one intra-train communications system, communicatively connected to the at least one position determining device. The intra-train communications system may include at least one master terminal configured to receive and store one or more packages of information originating from a master control station. The master terminal may also be configured to receive one or more train position signals from one or more train position determining devices. The master terminal may also be configured to present one or more messages to one or more users of the train. The messages may be obtained from one or more packages of information communicated to, entered into, or otherwise provided to the master terminal. The system may also include one or more inter-train communications system devices. Such inter-train devices may in communication with the master terminal and may be configured to receive and communicate by and between a master control station and/or a master terminal one or more train position signals and/or one or more packages of information.

The system may also be configured such that the master control station may generate one or more packages of information based upon a determination that the train is delayed with respect to reaching a given location along a transit route at a given time. Such delay may be determined based upon one or more train position signals received, for example, by the master control station and/or one or more packages including updated schedule information. The system may also be configured such that whereupon receipt of one or more packages, the master terminal may accordingly update any previously stored schedule information.

The system may also be configured such that one or more packages of information may include at least one message indicative of any updated schedule information, and whereupon receipt of the one or more packages, the master terminal may present the updated schedule information to one or more users of the train. The system may also be configured such that one or more packages are communicated by the master control station to at least one station platform at which the train is scheduled to stop. The system may also be configured such that any intra-train communications system may include at least one satellite terminal, located in a second car of the train. The satellite terminal may be communicatively connected to the master terminal utilizing a consist existing between the first car and the second car.

The system may also be configured such that upon receipt of at least one package of information, the master terminal may determine whether the package contains information relevant to the satellite terminal, and if so, communicate the relevant information across the consist to the satellite terminal. The satellite terminal may be configured to process one or more so received packages and extract and present at least one message to one or more users of the second car.

The system may also be configured such that at least one message may be presented to one or more users of a second car. Such message may provide, for example, scheduling information and/or emergency response information. The system may also be configured such that at least one message presented is generated by an operator of the master control station utilizing a pre-saved message. The message may also and/or alternatively generated using a message wizard, free text, text to speech, speech to text, translation, audible, any combination of the foregoing and/or any other messaging technologies. The system may also be configured such that the package of information includes at least one of scheduling information, audio file information, messaging information, operating system information, driver file information, scripting information, and program file information.

The system may also be configured such that at least one train position determining device is configured in a first car of the train. The train position determining device may include, for example, a global positioning system receiver. The system may also include an intra-train communications system that include at least one secondary communications network (e.g., a wireless communications network) communicatively connecting at least one satellite terminal to a master terminal. The system may also be configured such that the wireless communications network communicatively connects at least one user in a car of the train with at least one cloud based service provider via the at least one inter-train communications system device. The inter-train communications system may also be configured to establish a communications connection with at least one cloud based service provider. And the inter-train communications system device may be configured to establish a communications connection with the master control station utilizing a wireless communications system.

In at least another embodiment, a method for updating information utilized by at least one of a master terminal and a satellite terminal positioned in a car of a train may include receiving, by a master terminal, a package of information generated and communicated by a master control station, wherein the package of information is relevant to at least one or more cars of a train; storing the package of information in a database accessible by the master terminal; upon a rebooting of the master terminal, installing and executing the package, wherein the installation and execution of the package includes determining whether any element of the package is designated for at least one satellite terminal of the train; and when an element of the package is designated for at least one satellite terminal of the train, serving those elements of the package designated for the at least one satellite terminal to each of the at least one satellite terminals so designated.

The method may also include a package of information generated by a master control station based upon current configuration information, communicated to the master control station by the master terminal, for at least one of the master terminal and the at least one satellite terminal, and based upon such current configuration information one or packages of information are designated by the master control station for communication to the master terminal. The method may also include a package of information generated by a master control station based upon real-time position information communicated by the master terminal. The package of information may includes, in at least one embodiment, scheduling information, audio file information, messaging information, operating system information, driver file information, scripting information, and/or program file information. The may be designated for a satellite terminal and/or may be communicated by a master terminal to the designated satellite terminal using a consist existing within the train. The package may also and/or alternatively communicated using a wireless communications network, a non-deterministic network or otherwise. The communication of the package of information by the master control station may be repeated a pre-determined or random number of times, and/or until a confirmation of receipt is received from the master terminal. When communicated a pre-determined number of times and upon not receiving a confirmation of receipt of the package by the master terminal after the predetermined number of transmissions, a communications failure notification may be generated and/or provided to a system operator.

In at least another embodiment, a method for establishing communications between one or more cars of a consist may include establishing a first identifier associated with a first terminal located in a first car of a consist; establishing an electrical communications connection between the first terminal and a second terminal located in a second car of the consist; communicating, using the electrical communications connection, a wireless network identifier from the first terminal to the second terminal; and accepting, at the first terminal, a request from the second terminal to establish a wireless communications link between the first terminal and the second terminal using one or more wireless network signal characteristics associated with the wireless network identifier; whereby upon acceptance of the request from the second terminal by the first terminal a wireless communications connection is established between the first terminal and the second terminal.

The method may include, prior to communicating the wireless network identifier from the first terminal to the second terminal: receiving, at the first terminal, an identification of the second terminal; verifying the identification of the second terminal; and when the verification of the second terminal is not verified, identifying an error condition. In at least one embodiment, an error condition may identify a car, associated with the second terminal is not designated for the consist and has been connected to the consist.

A method may also be provided wherein the identification of a second terminal indicates to a first terminal that the second terminal can be configured as a master terminal. Such method may include determining if two or more terminals configurable as a master terminal have identified themselves on the consist; and if two or more terminals configurable as a master terminal have been identified, determining a priority between each of the terminals identified as configurable as a master terminal. In at least one embodiment, a priority determination may include determining which of the identified terminals configurable as a master terminal satisfy at least one challenge routine which includes an identification and ranking of at least one terminal parameter selected from a group consisting of a version of software installed onto the terminal, a challenge priority setting, a train car number, a position of a car associated with the terminal in the consist, a random number, and a unique network identifier.

In at least one embodiment, a method may include establishing an electrical communications connection between a first terminal and a second terminal using an audio communications link established between a first car and a second car of a train. The method may include establishing a second electrical communications link between the first terminal and the second terminal, wherein the second electrical communications link utilizes a power line connection between the first car and the second car to propagate communications signals between the first car and the second car.

In another embodiment a system for establishing intra-train communications between two or more cars of a train may include a first terminal in a first car of a train, wherein the first terminal is associated with a unique identifier; a second terminal in a second car of the train; a first wired communications link between the first terminal and the second terminal; and a wireless communications link between the first terminal and the second terminal; wherein the wireless communications link between the first terminal and the second terminal is established based upon a communication of the unique identifier from the first terminal to the second terminal using the first wired communications link. The first wired communications link may include an audio communications link connecting a first audio system in the first car with a second audio system in the second car. The first terminal may be configured to establish a wireless communications link with a second terminal upon verifying an identifier communicated by the second terminal to the first terminal using a wired communications link. The second terminal may be associated with a second unique identifier, each of the first terminal and the second terminal may be configured as a master terminal, based upon a result of a challenge routine between one of the first terminal and the second terminal. A wireless communications link between the first terminal and the second terminal may be established based upon the unique identifier associated with the terminal configured as the master terminal.

In at least one embodiment, a first terminal for use in a train consist may include

a first communications port configured for use in establishing an electrical communications signal connection between the first terminal and a second terminal; a second communications port configured for use in establishing a wireless communications signal connection between the first terminal and the second terminal; a data storage device, configured to store one or more operational parameters associated with the wireless communications signal connection; and a processor configured to output for communication to the second terminal through the first communications port, at least one of the one or more operational parameters associated with the wireless communications signal connection. The first communications port may be configured to output one or more electrical communications signals to the second terminal utilizing a power line based communications protocol. A power line based communications protocol that is LonTalk compliant may be utilized. The first communications port may be connected to an intra-train audio communications link, and the electrical communications signal connection between the first terminal and the second terminal may utilize the audio communications link. In at least one embodiment, one or more operational parameters utilized may include a service set identifier and/or a listing of one or more media access control identifiers. A data storage device may be utilized to store a computer-executable code that, when executed by the processor, causes the terminal to perform the operations of: receiving an identification of a media access control identifier from the second terminal; determining whether the received media access control identifier is listed on the listing of one or more media access control identifiers; and when the received media access control identifier is listed; and/or communicating, using the first communications port, at least one parameter required to establish a wireless communications connection between the first terminal and the second terminal. At least one parameter communicated may include a service set identifier and a password.

Additional features and advantages of the before mentioned and other embodiments will be set forth in the description which follows, and in part will be obvious from the description, or may be learned by the practice of the embodiment(s). The features and advantages of one or more of the various embodiments may be realize and/or obtained by use and/or practice of the instruments, combinations, systems, operations and/or methodologies particularly pointed out in the appended claims and/or in any future arising claim in this or a related application. These and other features of the various embodiments will become more fully apparent from the following description and appended claims, or may be learned by practice of one or more embodiments as set forth hereinafter.

### BRIEF DESCRIPTION OF THE DRAWING FIGURES

To further clarify the above and other advantages and features of the various embodiments described hereinafter, a more particular description of at least one of such embodiments will be rendered by reference to specific implementations thereof which are illustrated in the appended drawings. It is to be appreciated that these drawings depict only one or more embodiments and are therefore not to be considered limiting of any embodiments scope. The various embodiments will be described and explained with additional specificity and detail through the use of the accompanying drawings in which:

FIG. 1 is a schematic representation of at least one embodiment of a multi-tier transit update system.

FIG. 2 is a schematic representation of at least one embodiment of an intra-trains communications system.

FIG. 3 is a schematic representation of at least one embodiment of an inter-train communications system.

FIG. 4 is a schematic representation of at least one embodiment of the operating modules utilized by a master control station.

FIG. 5A is a pictorial representation of a screen display presenting on multiple operator's monitors information relating to a “map” display and a “status” display as utilized in conjunction with at least one embodiment of a master control station of a multi-tier transit update system.

FIG. 5B is a pictorial representation of a screen display presenting on at least one operator's monitor information relating to a “status” display as utilized in conjunction with at least one embodiment of a master control station of a multi-tier transit update system.

FIG. 6 is a pictorial representation of a screen display presenting on at least one operator's monitor information relating to a “routing” display as utilized in conjunction with at least one embodiment of a master control station of a multi-tier transit update system.

FIG. 7 is a pictorial representation of a screen display presenting on at least one operator's monitor information relating to a “station/end of line” display as utilized in conjunction with at least one embodiment of a master control station of a multi-tier transit update system.

FIG. 8 is a pictorial representation of a screen display presenting on at least one operator's monitor information relating to a “system” display as utilized in conjunction with at least one embodiment of a master control station of a multi-tier transit update system.

FIG. 9 is a pictorial representation of a screen display presenting on at least one operator's monitor information relating to a “playback” display as utilized in conjunction with at least one embodiment of a master control station of a multi-tier transit update system.

FIG. 10 is a pictorial representation of a screen display presenting on at least one operator's monitor information relating to a “messages” display as utilized in conjunction with at least one embodiment of a master control station of a multi-tier transit update system.

FIG. 11 is a flow chart depicting one embodiment by which packets may be communicated, installed and executed by a master terminal and/or one or more satellite terminals in a train in accordance with at least one embodiment of a multi-tier transit update system.

### DETAILED DESCRIPTION

The various of embodiments described herein generally relate to apparatuses, systems and/or methods which utilize multi-tier transit updating systems. In at least one embodiment, the operation, location and information relating to one or more trains are updated and communicated using positioning information sources, wireless telecommunications systems, intra-vehicle communications systems and other communications elements. Such system components desirably facilitate the reception by trains of information relevant to their operations and the providing of similarly train relevant information to vehicles, operators, engineers, administrators, passengers and others. Recipients of such transit related information may include persons, devices and/or systems located at any of numerous locations including, but not limited to, vehicles, station platforms, control stations, switching stations, routing stations, emergency responders locations, mobile devices and others. Such information may received and communicated automatically, semi-automatically, manually or otherwise.

Trains may further include various components such as one or more cab cars and trailer cars. A cab car herein refers to a vehicle with a source of propulsion, such as an electric motor, a diesel electric motor, or other form of propulsion generating mechanism(s). A cab car may also include, but is not required to include, a passenger area and/or a cargo area. A cab car is commonly the first car in a train and is typically the location in the train at which an “engineer” resides. The engineer is typically the person (or component, in the case of fully automated systems) responsible for driving and/or otherwise operating the train. A trailer car is typically a component of a train, a collection of trailer cars is commonly and herein referred to as a “consist.” Trailer cars may also include a source of propulsion, such source of propulsion may be active or inactive at any given time and/or for any given configuration of the train. Trailer cars may be utilized to provide passenger compartments, cargo compartments and/or other compartments, such as dining, sleeping, and entertainment. The safety and operation of trailer cars and passenger/cargo areas of cab cars, are commonly and for purposes of the embodiments discussed herein the domain of one or more “conductors.” Transit systems in accordance with the various embodiments discussed herein also include one or more system operators and administrators. As discussed in greater detail below, system operators may monitor, control and perform other functions relating to system wide and train specific operations including but not limited to scheduling, announcements, emergency response, train control and other transit related functions. System administrators are generally responsible for the administration of the various hardware and software systems utilized in the various embodiments discussed herein.

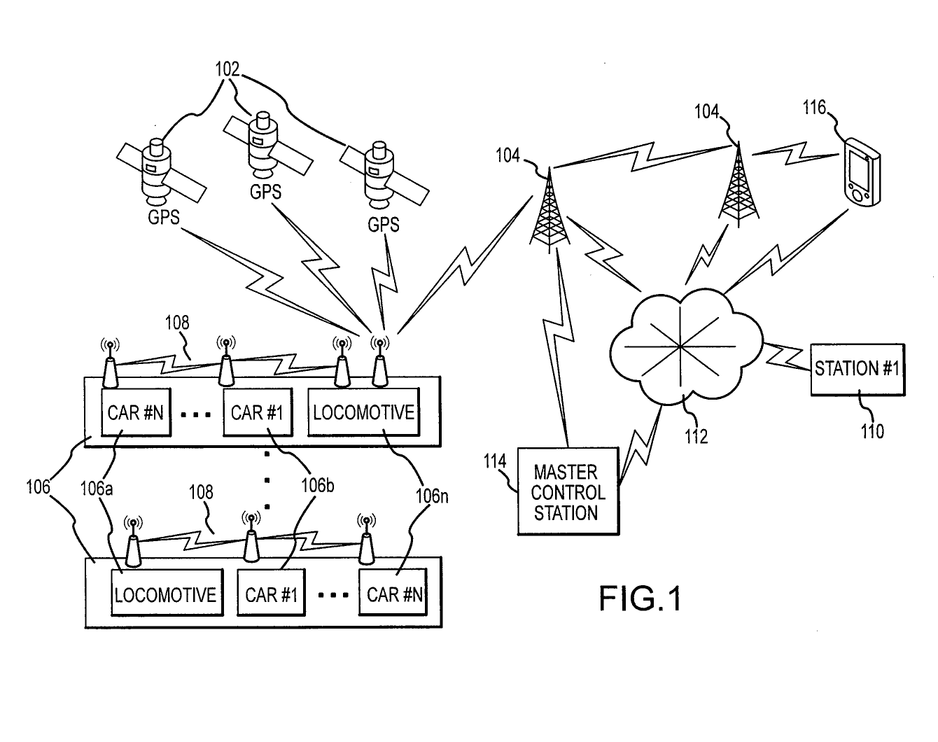

One embodiment of a system for providing multi-tier, automatic transit updating and control system, is shown in FIG. 1. Using such a system, various types of information relating to transit operations can be received, disseminated, updated and otherwise utilized. System operations can also be controlled. Information of various types and format can be utilized including at least one of location, scheduling, operation, maintenance and other transit system related information. As shown in FIG. 1, an embodiment may include and/or utilize one or more of the following functional components: positional information systems and signals 102, for example, those provided by one more global positioning satellites; telecommunication systems 104 which may include external and internal communications systems of various formats and protocols, including but not limited combined wired and wireless intra-train communications systems 108; at least one cab car 106a and one or more trailer cars 106b and 106n; one or more stations or platforms 110 at which the train commonly loads and unloads passengers and/or cargo; one or more external communications networks 112, such as the Internet, referred to herein as a “cloud”; one or more master control stations 114; and one or more mobile devices 116, for use by passengers, operators, administrators, emergency responders, maintenance personnel and others involved in the operation or use of the system 100. Each of the system components are desirably interconnected using one or more network topologies including, but not limited to, the Internet, an internet, local area networks, wide area networks, cellular networks, Long Term Evolution (LTE) networks, radio networks, Wi-Max networks, power lines, satellite, and other future communications topologies and combinations thereof. Further, it is to be appreciated that one or more components may be removed from the system or inaccessible by the system, from time to time, while still providing a multi-tier, automatic transit updating and control system. Each of the system components are described herein in greater detail below.

Positional Information Systems and Signals

One component of the system embodiment shown in FIG. 1 provides positional information systems and signals for use in determining a position of various transit elements, such as a train 106, at any given time. In one embodiment, such positional information signals are provided by Global Positioning Satellites (GPS) and the position of any given train is determined using receivers, antennas and other known in the art components configured for receiving and processing GPS signals, and based thereon determining a position of the receiving device, and by extension thereof—a vehicle, in at least measurements of latitude and longitude, and optionally in altitude. Numerous types of GPS receivers, processors and other positional and/or navigational system components are well known in the art, many of which may be suitably utilized to support the various embodiments discussed herein. Selected GPS system components desirably are capable of meeting the reliability, robustness, accuracy and other characteristics identified for various embodiments described herein. For at least one embodiment, the GPS system components utilized are desirably web enabled and will enable remote authorized users to interact with such system components in accordance with their respective access authorization levels and as necessary.

The GPS system components, and other components of the various embodiments discussed herein and/or claimed hereby, for at least one embodiment are robust and can tolerate varying environmental conditions. Such varying environmental conditions may include temperatures ranging from −40° C. to 70° C. and conditions including snow, ice, rain, hail, sand storms, high winds, the presence of acids, salts, pollutants, corrosive materials, dust and other environmental conditions. Other environmental conditions may include those arising in and/or from the use of radio frequency, electrical, optical and/or other components which utilize electro-magnetic signals, optical signals and/or other signal types in the transmission, reception, processing, storage, presentation or otherwise of data and/or information. Other environmental conditions and concerns may include the prevention from vandals and other non-desired human interference with system components, including but not limited to GPS system components, is also desirable for at least one embodiment. To accommodate these extremes in environment, operations, security and other variables, in at least one embodiment, GPS and other system components may be combined with and or housed in other system components which are suitably positioned, configured and secured in view of the foregoing and/or other concerns. For example, GPS system components and telecommunication systems components (which are discussed in greater detail below) may be combined and locked in secure compartments. Antennas, power components, displays, control/user interfaces and other components may take any desired form, shape, size or configuration as particular implementations of the various embodiments discussed herein suggest, desire or require. For example, certain antenna types having a high profile may not be compatible when trains operate in environments having low clearances. Likewise, certain forms of antenna, in terms of receptivity to GPS, offset GPS, and other forms radio frequency signals, may be preferred over other antenna/system configurations. Geographical considerations, such as the presence or absence of foliage, whether the system includes tunnels or subways, mountains, the availability or unavailability of alternative location information sources, such as those provided by cellular telecommunications systems and other factors, may also dictate the selection of certain GPS components and systems. The selection of GPS components and systems in furtherance of the various embodiments discussed herein and in view of the environmental and operational constraints discussed herein or commonly occurring for transit operations are suitably within the skill set of a person of ordinary skill in the art and thus are not discussed further herein in extensive detail.

The GPS system components in at least one embodiment are capable of providing positional determinations to within one (1.0) meters, speeds at 0.1 meters/second, elapsed time, remaining distance and time to a given destination, average speeds, stopped versus moving times, “at platform” elapsed times, and other information relating to transit operations. Such information may be reliably calculated over a range of speeds including from zero (0) to well over several hundred kilometers per hour, as may occur with the use of system components on high speed rail, aircraft, and future forms of transportation.

The GPS system components and other systems components that emit electromagnetic energy, are desirably environmentally friendly, as measured in terms of at least the radio frequency (RF) and electro-magnetic emissions environment in which such components are utilized. That is, the GPS system in at least one embodiment is designed to not exceed maximum emission characteristics, which may be dictated in terms of the frequency, energy and direction of propagation for RF emissions. Such emission characteristics are desirably specified to prevent, minimize and/or operate within given tolerances such that the emission of RF and electromagnetic energy does not cause undesired interference or effects with, between and/or on intra-transit system, inter-transit system and other non-transit system components, such as local area networks and cellular networks, other system components, humans, animals or otherwise.

While the embodiment of FIG. 1 utilizes GPS systems for such positional determinations, it is to be appreciated other system or method for suitably determining a position and other characteristics of operation of a transit vehicle may be utilized. Examples of such alternative methods include but are not limited to, cellular tower triangulation methodologies, transit system sensors, for example those embedded in a railway, time, distance and speed calculations, the use of mile posts and control points and other forms of position and rate determination techniques may be utilized in any combination or configuration desired.

Telecommunication Systems

As shown in FIG. 1, at least one embodiment includes various telecommunications systems components including those external to a train, such as telecommunication system 104, and those internal to a train, such as intra-train communications system 108. It is to be appreciated that such telecommunications systems components may be interconnected to various other system components, such as the before mentioned GPS system and other components, for example, those configured to provide positive system control (fail-safes) of transit components from remote locations, as may be necessary in the event of a train engineer being unable, for example due to health reasons, or otherwise unavailable to operate any given train.

Intra-Train Communications Systems

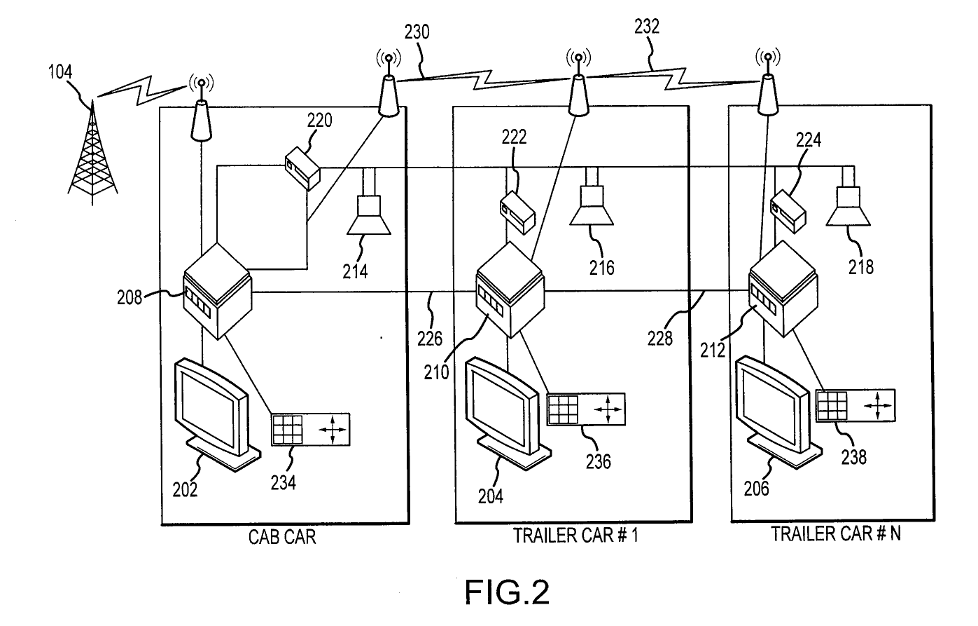

Various forms of telecommunications systems may be utilized to provide connectivity for data, voice, control and other types of information signals between the various cars, the consist, and one or more locomotives consisting of a train. In at least one embodiment, as shown in FIG. 2, an intra-train communications system 108 may include, but is not limited to, visual display devices, as such LED signs 202, 204 and 206. Other forms of visual display devices may be utilized. Audible presentation devices, such as public address intercoms 214, 216 and 218 may be utilized and may take any form, ranging from bi-directional intercoms, to single direction speakers and microphones. Also, the placement and number of LEDs and audible presentation devices may vary, as desired for any given implementation of an embodiment discussed herein. Cab car communications units, herein called Master Terminals (MTs), 208 and trailer car communications units, herein called Satellite Terminals (STs) 210 and 212 may also be utilized. MTs and STs may be connected to various other forms of telecommunications devices including, but not limited to, amplifiers, switches, routers, data ports and other components used to provide wired and wireless communications; such components are simplistically and collectively represented in FIG. 2 as telecom devices 220, 222 and 224. Various wired interconnections may be used, including, but not limited to, existing power lines and/or public address connections that commonly connect legacy cars over a consist with a cab car. More specifically, such interconnections may include those between consist cab cars and trailer cars such as cab to consist connection 226, and those connections between multiple trailer cars, such as intra-consist connection 228. Such connections may use any carrier or medium suitable for the desired signal propagation of electrical, light or other mediums bearing the desired information, such mediums commonly include copper wires of various sizes, shapes and configurations, fiber optics cables, electromagnetic couplers and others. In at least one embodiment, the LonWorks protocol is used for data transmitted over such wired, legacy train to consist and intra-consist connections. Other communications protocols may also or alternatively be utilized. Wireless connections may be provided between cab and consist and/or between consist cars, such as connections 230 and 232. Various control elements and user interfaces may be utilized, such as cab keypad 234, and trailer keypads 236 and 238. It is to be appreciated that such control elements and user interfaces, herein collectively a “keypad,” may communicate with a MT and/or ST via wired and/or wireless communications links and may include any form of audible (including microphones and speakers), visual (including displays and cameras), textual (including keypads, touch sensitive pads, scratch pads and the like), biometric (including fingerprint, voice, retina or otherwise) and/or other forms of user interface and/or control functions for use with a data and communications system. Keypads may also be provided, with operators, conductors, passengers or other persons using common telecommunications devices, such as smart phones, cellular phones, tablet computers, laptops or any other so compatible devices configured with any desired application programs and routines (or actual hardware devices), that enable such communications device to connect with the wired and/or wireless communications systems present in any given train, in accordance with at least one embodiment discussed herein. The preceding systems and/or other intra-train communication system components may be added or removed from any given implementation of the embodiments described herein.

In at least one embodiment, an intra-train communications system may be configured to adaptively identify and limit intra-train communications to those cars electrically interconnected across a given train's consist. As is commonly known and appreciated, consists often vary by day of the week and by the time of day as to the individual cars, both cab and trailer cars utilized therewith. For example, on weekdays and especially during rush hours, a consist may include additional trailer cars to carry increased passenger loads. Contrarily, after work hours or on weekend days, when passenger loads may be lighter, a consist may include less trailer cars. Similarly, some lines may require trains with larger or smaller consists, based for example on station configuration limitations and other factors. Further, cab and trailer cars are routinely cycled in and out of service based upon maintenance, repairs and other system requirements. As such, it is to be appreciated that a given consist, for any given day, and for any given schedule may dynamically change from time to time and day to day.

To accommodate these variations in the configuration of any given consist, while also providing a secure intra-consist communications system, one or more of the various embodiments discussed herein desirably facilitate communications between all the cars of a consist, regardless of a consist's then or changing configuration, based upon a combined wired and wireless communications system. In at least one embodiment, a wired connection supporting intra-consist communications may be accomplished by utilizing common audio signal wiring. Such audio signal wiring typically interconnects train cars of both legacy and modern design to provide consist wide capabilities for announcements and other audible messaging. By utilizing existing and commonly available audio wiring connections, a low data rate communications path may be established between each terminal (STs or MTs) in each car of a given consist.

To support and provide high data rata communications capabilities within and between cars of a consist, an intra-consist communication system may also include one or more wireless system components. Such components may be located in each car or provided for a group or collection of cars. That is, each car (and/or grouping thereof) in a consist may be configured with a wireless component that is connected to or built into each car's terminal, for example, an ST or an MT. A given car's terminal may be configured as an ST or a MT, with each train having at least one MT. As described herein, a terminal may be connected to a car's existing audio wiring connections such that any given terminal in any given car of a consist is communicatively and electrically connected to each of the other terminals in other cars of the consist.

Further, at least one embodiment described herein also provides for intra-consist communications over a common wireless communications link. Such wireless communications link may be associated with a secure link that provides for encrypted data transfers that are limited to approved terminals. In at least one embodiment, each consist includes at least one MT providing wireless communications capabilities. Each MT may be assigned a unique service set identifier (SSID) or similar identifying code. As is commonly known and appreciated, SSID codes are commonly utilized to identify a wireless local area network. SSID codes can be broadcast or non-broadcast. In at least one embodiment, an SSID associated with the MT for a given consist is not broadcasted over the wireless network. Instead, as cars are added to a consist, the terminal (ST or MT) associated with the newly added car announces its presence on the wired network and in response thereto the MT communicates the SSID over the wired network to the ST in the newly added car. In addition to the SSID, passwords and/or other codes and settings used to secure any wireless communications between the cars of the consist may also be communicated over the hard wired connection to the newly added terminal. The hard wired connection may also be used to send consist wide updates on communications protocols, settings and other configuration parameters (i.e., a new SSID) to existing and/or newly added terminals in cars forming the consist. In this manner, communications protocols and addresses associated with a given wireless local area network (WLAN) for a given consist may be communicated securely using hard wired, and commonly available low data rate connections, such as intra-consists audio system wiring, which typically exist in both legacy and modern cars forming any given consist.

Each terminal (an ST or an MT) for each car of a consist may also be configured to have a unique identification code, such as a Media Access Control (MAC) address and/or other identifier that is uniquely associated with the given terminal. The MT for each consist may be further configured to allow access to the WLAN associated with the consist to only those terminals whose MAC address have been expressly allowed in a MAC address table or similar listing maintained by the MT. Such listing may be provided by system operators, conductors or others (including automatically) on a daily or other basis, for example, when the consist is being formed at the start of any given operating day. The listing of cars and terminals associated therewith forming a consist may also be provided wirelessly to multiple terminals in multiple cars forming some or all of a consist. Thus, the MAC listing or other listing of car and/terminal identifications may be provided in multiple and redundant locations for a transit system, thereby providing additional control and reliability for system configurations, control and secure communications.

In at least one embodiment, an MT for a consist may be configured to verify one or more parameters associated with an terminal (and car associated therewith) connected to and/or desiring to be added to a consist. For example, an MT may be configured with a series of MAC addresses or other identifiers associated with each of the terminal in those cars to be added to a consist. As a car is connected or a terminal therewith reconfigured, the MT may request the newly joined or reconfigured terminal to announce its MAC address. If confirmed, the terminal is allowed to join the consist's network. If not confirmed, the MT may communicate an alarm to a system operator, maintenance personnel or others identifying the addition of a non-approved terminal (and car associated therewith) onto the consist. For example, a terminal having a version of an operating system that is incompatible with the version of operating system currently utilized by the MT for the consist may trigger an alarm or alert condition to system operators, maintenance personnel, conductors or others.

Other identifiers in addition or as an alternative to an terminal's MAC address may also be utilized to identify and confirm a terminal for connection to a given consist. Examples of such other identifiers include, but are not limited to, a car number, line number, schedule number, conductor identifier, date/time identifier, a random number, capabilities of the terminal and other parameters.

A system operator, engineer, conductor, maintenance person or other person or system having sufficient access and privileges to a given car's terminal may need to reconfigure a terminal with the proper identifier(s) needed to establish communications with a given NT and across the consist. The configuration of a terminal with respect to a consist may also and/or alternatively occur remotely by a system operator connecting directly, or indirectly, to the terminal. For example, a terminal with inter-train communications capabilities may be reconfigured remotely to be compatible with a given consist's communications and other operational configurations. It is to be appreciated that by establish the communications network and providing access to the same based upon and only to confirmed terminals, the risk of intrusion by unauthorized sources onto a consist's wired and wireless network may be reduced.

The providing of a secure low data, hard wired connection in combination with a wireless, secure high data connection that is unique to a given consist, in at least one embodiment, also enables system operators, conductors and others to update a series of terminals, for a consist, collectively and securely. Further, the wired and wireless communications topology described herein also enables system operators to quickly assemble and configure any given consist's communications topology by broadcasting WLAN access information over the hard wired connection to each of the terminals in the group of electrically interconnected cars all at one time. Such capability desirably minimizes the need for a conductor, engineer or other person to separately configure a terminal in each car forming any given consist.

Such a multiple car connection configuration capabilities may also be used when reconfiguring an existing consist to support the addition or subtraction of one or more terminals. For example, when a cab car containing an MT needs to be replaced by another cab car containing a second MT, the updating of all of the remaining terminals in the consist to the second MT's WLAN configuration parameters can be accomplished by a broadcast of the new MT's wireless configuration parameters across the low data rate, wired connection. Each terminal on the consist receiving such hard wired communications can then reconfigure their operations accordingly without reduced concern of an unauthorized signal being communicated to them, as might occur with a less secure wireless communications topology.

In at least one additional and/or alternative embodiment, each car of a consist may be connected to a common power line. Using the LonTalk protocol, or other power line data communications protocols, a low bandwidth power line based data network may be established between a terminal in each car with an MT providing a WLAN. It is to be appreciated, that the power line network may be used to communicate the same information communicated over the audio lines and/or additional information. In at least one embodiment, the power line network may be utilized as a back-up or fail safe network, in the event that the audio line and/or wireless networks were to fail or malfunction. In other embodiments, the power line network may be utilized as a replacement for the wireless network, wherein the audio lines network is utilized to control access to intra-consist high data rate messages communicated over the power line network. It is to be appreciated that in yet another embodiment, the roles and functions of the audio line and power line networks may be reversed and/or augmented, as desired.

Any given consist may include one or more terminals that are configurable as an MT. As discussed herein, in at least one embodiment, only a single MT exists for any given consist at any given time. As such, whenever one or more MT capable terminals are connected to a given consist, a challenge routine may be performed by which a determination may be made as to which of the two or more available terminals shall be designated as the MT, with the remaining terminal(s) being configured into an ST mode of operation. The challenge routine may include an identification and ranking of terminal parameters, such as, version of software, challenge priority settings, train car numbers, position and role of the car in the consist (e.g., locomotive versus baggage car), a random number, a unique network identifier or other parameter. For example, the terminal with the most current version of the software may be designated as the MT. Similarly, a terminal having a higher priority setting based upon another factor, such as a car associated with a senior conductor, may be designated as the MT.

Similarly, when an existing MT of a consist is disconnected from the consist or otherwise loses connection with the other terminals in the cars comprising the consist, a challenge routine may be executed amongst the terminals that are MT capable in the remaining cars of the consist. The terminal best satisfying the challenge routine is then identified as the new MT for the cars remaining in the consist.

In another embodiment, the wireless communications network may be configured as a hybrid or distributed network without any centralized controller, thereby providing redundancy capabilities should an MT or ST go off-line or lose connectivity at any given time. For example, should the wireless network experience interference or other system degradations and/or should a power or audio line become disconnected, the remaining connected cars in the train may be configured into a spoke and hub arrangement wherein any given terminal in a series of cars is configured as an MT and the remaining terminals for the series of cars are designated as STs. In such an embodiment, a train may have multiple MTs, with each MT controlling one or more STs that are within RF frequency of the MT or are within audio and/or power line communications range of the MT. In at least one embodiment, each MT, in a multiple MT consist, may be configured to communicate directly with system operators. Alternatively, one of the multiple MTs in a consist may be designated as a master MT, with all other MTs for the consist communicating directly to the master MT and not directly with system operator or others. As such, it is to be appreciate that the various embodiments described herein facilitate secure and adaptable intra-train communications by utilizing a hybrid of hard wired circuits, such as those provided by audio and/or power lines, and secure wireless circuits, wherein the operational parameters of the secure wireless circuits are communicated via the hard wired communications links to multiple terminals in a consist.

Referring again and as discussed above and as shown in FIG. 2, in at least one embodiment LED signs and other forms of visual information presentation devices may be utilized. Such display technologies are collectively referred to herein as “LED signs” but it is to be appreciated that any known or future type of visual presentation device, systems or methodologies may be utilized in various embodiments. The LED signs may be utilized to provide any form and type of recorded or live information, including live information provided by remote system administrators. The sources of such visual information may be local, as provided by local storage and/or local image capturing devices, or remote such as those provided by centralized storage and/or image capturing devices. Examples of such information generally include, but are not limited to, location, scheduling and emergency information. Such information may be relevant to all or some of the passengers, engineers, conductors, maintenance personnel, emergency responders, operators, administrators or others with respect to any given transit system, train, consist, car or element thereof. The information provided via the LED signs may be in any language(s), format, type, size, dimension (including three dimensional) and may include any form of visual information such as graphical, textual, video, still images, and other forms and/or combinations of visual information.

More specifically, the information provided by the LED signs may relate to any topic or subject. For example, information may be provided which: informs passengers of delays and arrival times; identifies attractions or other points of interest at stations and/or along a transit route; identifies merchants, schools, governmental buildings, hospitals and other governmental or public institutions; identifies location and/or geographically relevant information; provides general, location or context based advertising messages; provides entertainment; provides directions or other transit related information, such as connecting information, platform configurations, directions to connecting gates, locations of certain loading or unloading areas, baggage drop-off and recovery areas, and other transportation related information that may be relevant to a passenger arriving at a multi-modal transportation station such as one that may exist at a train depot, an airport, bus terminal, taxi stand, rental car terminal or other multi-modal transportation area; emergency information, such as instructions on/how/when to evacuate a car, administer first-aid, or as otherwise appropriate; general public interest announcements (e.g., the Cubs win the World Series); maintenance information; and/or any other type of information that may be relevant to any person using or involved with the train or transit system. Further, the LED signs may be used, in certain embodiments to provide multi-party visual communications capabilities, for example between conductors, operators, passengers, emergency responders and others. Closed captioning and other messaging for the hearing impaired and others may also be provided. In short, the LED signs enable practically any type of visual information to be provided to passengers and others involved in the use of such trains.

Referring again to FIG. 2 and in at least one embodiment, the intra-train communications system includes at least one MT 208 and a ST 210, 212 in each trailer car. Each train desirably has at least one MT, but, may have one, none or any number of STs. In at least one embodiment, each trailer car has their own ST. However, in other embodiments, two or more trailer cars may be configured to utilize a common ST. Such groupings of STs may be utilized, for various purposes, including but not limited to, providing system redundancy, improving system operations, facilitating system expansion and capabilities, enhancing reliability and troubleshooting. Further, for at least one embodiment, a given ST may be configured to function as a MT and vice versa. Similarly, STs may be configured in various embodiments to provide all of the functional capabilities of MTs and vice versa. Such flexibility may be desired, for example, when a train consists of light rail components, any of which cars may be utilized, on any given day and/or with respect to a given direction of operation, to function as the lead or cab car. MTs and STs, in at least one embodiment, are provided by utilizing ZyWAN control units, such as those manufactured by EUROTECH who's corporate office is located at 10260 Old Columbia Road, Columbia, Md., 21046, in the United States of America. Other forms of data processing units may be utilized, in conjunction with or separately from the ZyWAN units, to provide MT and ST functionalities, examples of such devices include, but are not limited to, general purpose processors such as those found in personal computers and similar devices, special purpose processors, such as those found in gaming systems, satellite systems and other devices, and other forms of computing and processing devices that are capable of providing the data processing, routing, control and configuration requirements desired for at least one embodiment discussed herein. Further, the processors utilized in MTs and STs may utilize “Cloud” based computing options wherein a minimum needed data communication and processing capability is present in the MT/ST with more capable and extensive data processing capabilities being off-loaded onto the “cloud” and provided by various services and servers, located off-train, that are suitably in communications with any given train.

In at least one embodiment, a master and slave relationship may exist between a MT and one or more STs. Each MT and ST desirably utilizes an operating system (OS) that is upgradeable, reconfigurable and scalable. The OS may based upon open source software, such as Linux, and/or may be based upon proprietary software. Various middle ware applications may also be utilized including Java and others. Various application programs may be supported including, but not limited to, short message service transmissions including text messages, instant messages, and others. The MT and ST units also may include, but are not limited to, one or more combinations of the following components and capabilities: ports for LED signs; ports for GPS and other data receiving and/or processing components including antenna connections, receivers, data and/or signal processors, storage devices and other electronic devices, any of which may be provided on modular cards or built-in or otherwise connected; antenna and other ports and/or internal modulators and other communications signal processing components which may support and be compatible with various wireless protocols including, but not limited to, EVDO, CDMA, TDMA, GPRS, iDEN, Bluetooth, 802.11a, b, g, n; ports for LAN and Ethernet; ports for USB, Firewire, Compact Flash (CF), Secure Digital (SD), and other forms of connections for external devices; ports for car sensors such as security cameras, motion sensors, temperature sensors, environmental sensors and others, such sensors may be distributed throughout a train and/or a car in any desired configuration; power connections; and communications ports for connecting with intercoms 214, 216 and 218 and other telecom devices 220, 222, 224. MT and ST capabilities can be tailored to fit any given operational environment. In at least one embodiment, each MT and ST includes 256 Megabytes of dynamic SDRAM. Other forms, types, capacities and sizes of data storage technologies may alternatively and/or additionally be utilized as desired.

In at least one embodiment, a MT/ST may be configured to receive signals from car door sensors. Such sensors may be configured to indicate when a door is open/closed, whether a passenger request to open a door is received, whether and when a door is interrupted during a closing sequence, whether a door is opened at a location other than a station (if so, where, as may be determined based upon GPS or other positional information), the length of time a door is open and other information related to door operations or use thereof. Such information may be utilized by conductors to identify trailer cars where, perhaps a passenger requires their attention, system administrators to measure station dwell times and causes of extended delays, such as doors being ajar, and for other purposes such as emergency and maintenance. For example, security personnel may utilize door sensor information, separately or in conjunction with other sensor information, to identify a safety or security situation that may be arising in a given car or compartment thereof.

In FIG. 2, the connectivity between a MT/ST and other system components is depicted as being a combination of wired and wireless connections. In one embodiment, such connections desirably provide at least 19.2 Kbps of data communications over wired links using public address and other control signaling functions. The LonWorks data protocol may be utilized, for example, to provide the desired data throughput capabilities over wired communication links, including those commonly existing in many legacy train cars. In various embodiments, communications needs may be satisfied by also providing an over-the-top wireless communications architecture which desirably supports at least 30 Mbps using Ethernet protocols. Lesser or greater data connectivity rates, however, may be provided in other embodiments.

It is to be appreciated that any connectivity architecture may be utilized to interconnect STs and a MT and to connect components thereto, such as LED signs, which in certain embodiments may be wirelessly and/or hard-wired connected to a ST or a MT. Such architectures may include, but any desired combination, as specific system implementations may dictate, of wired and/or wireless connections. Such connections may utilize legacy wiring, dedicated wiring, non-dedicated wiring such as those provided by power lines and public address circuits, network topologies, wireless topologies or any combinations thereof. Further, wired and wireless communications links may be provided between train passengers, conductors, operators and others. For example, wired and wireless intra-consist and cab to consist communication links 228/232 and 226/230, respectively, may be utilized to provide LAN capabilities. As discussed below in greater detail with respect to an inter-train communication system, such LAN may be connected to a wide area network (WAN) such as the Internet using various communications topologies.

As such, it is to be appreciated that a train and any components thereof, such as cab cars and trailer cars, may include any desired configuration of audio, visual, data, location, environmental, door sensor, communication, networking, security or other communication system capabilities. Such embodiments may use any configuration of wired and/or wireless topologies and protocols as desired for any given implementation of the various embodiments discussed herein.

Inter-train Communications Systems

With reference to FIGS. 1 and 2, at least one embodiment provides communications capability 104 between a train and at least one other location. Such communications capabilities can be provided via any configuration or combination of telecommunications architectures including, but not limited to: wireless systems such as those compatible with the CDMA, CDMA2000, TDMA, GPRS, EVDO, LTE, and other wireless protocols; traditional wired telephone communications systems, including DSL links; Wi-Max systems; satellite systems; cable systems; radio-frequency communication systems such as C-Band radios, microwave systems and optical systems (such as fiber optic and other laser or light based communication systems), and any other form communications systems or combinations thereof. Various networking topologies may also be utilized in conjunction with the architectures including, but not limited to, the Internet, LANs, WANs, the world wide web, proprietary networks, open networks, Integrated Services Digital Networks, Digital Subscriber Line networks and others. In at least one embodiment, data transfer rates of at least 1.5 Mbps are supported by telecommunications system 104. For any given telecommunication system 104 utilized with any of the embodiments discussed herein, such system may have the necessary power, coverage and connectivity characteristics to provide uninterrupted signals across the entire span of a train's travels and also throughout the operating speeds of any such given train, including trains operating at speeds greater than many hundred kilometers per hour. The telecommunications system architecture for at least one embodiment also supports real-time updating of information, schedules, announcements and other information to/from system components. For at least one embodiment, inter-train communications links are desirably available at least 98.9% of the time and reliable (without dropped connections, substantially decreased data rates or high latency) 95% of the time. For other embodiments, higher or lower levels of availability, latency and reliability may be acceptable.

Any of the numerous forms of audio, video and data encoding, compression, scripting and/or communications technologies may be utilized, as supported by any given network architecture, examples include but are not limited to: MPEG-Audio, MP3 audio, Advanced Audio Coding and other audio compression and encoding/decoding technologies; MPEG, MPEG-2, MPEG-4, Advanced Video Coding, Flash, JPEG, motion JPEG, and other video compression and encoding/decoding technologies; HTML, HTML 5, XML, and other mark-up languages; and other technologies which support the communication of audio/video and/or data information by, from and/or between one or more transit system components with one or more other transit system components, wherein such components may be internal and/or external to one or more trains.

Stations and Mobile Connections

As shown in FIG. 1, the telecommunications system 104 desirably supports, via for example the “Cloud” 112 or directly, communications amongst multiple system components including multiple trains 106, station platforms 110, master control stations 114 and mobile devices 116. More specifically, the various embodiments discussed herein facilitate the providing of various forms of transit related information to various users and user groups. As discussed below in greater detail in conjunction with a discussion of the operation of the various embodiments of the systems discussed herein, such information may include real-time scheduling information, for example, when a train is actually going to arrive or depart from any given station.

In at least one embodiment, each station 110 of a given transit system desirably includes those audio/video/data presentation components needed to support a given level of service. For example, stations may include LED boards that provide visual and/or textual information relating to when a given train will arrive. Similarly, audio presentation devices may be utilized to provide audible announcements, such as an update on the estimated arrival time of a train on a given platform, how many cars are available, which cars are full or have empty seats, and other transit related information. Suitable devices may be provided for the visual and/or hearing impaired. Information provided via station audio and visual presentation devices may also refer recipients to other sources of information, such as that provided on various web sites. For example, information announcing a delay or cancellation of a train may include a referral to a website at which alternative connection options may be identified, based upon a desired route or destination. Such information sources may also present, for example, URLs or other indicators of sources of web, Internet or otherwise available information that may be relevant to a given user(s) transit needs.

The information provided to station platforms 110 may also be provided via the communications system 104 and/or the cloud 112 to various “mobile devices.” For purposes of this discussion a mobile device is considered to be any electronic device, regardless of size, form or primary function, by which a person can receive relevant information relating to the operations of a transit system or components thereof. Examples of such mobile devices 116 include, but are not limited to, wireless telephones, smart phones, tablet computers, personal computers, laptop computers, pagers, gaming consoles, satellite and cable system receivers, radio systems and any other device capable of conveying relevant information via communications systems 104 and/or the cloud 112 to the intended recipient(s). Such mobile devices 116 may be located wherever convenient to the recipient for the intended purpose.

More specifically, transit users may utilize mobile devices that provide updates on transit related information. For example, a passenger on a given train may be provided, via their mobile device and one or more network connections, which may include intra-train connections or inter-train connections, arrival time updates and connecting information. Similarly, conductors, operators, emergency responders with mobile devices may be suitably notified and informed of transit operations, train operations and even individual car operations, as the case may be. For example, an emergency responder may be informed of a train's estimated arrival time at a given station platform and the car in which their assistance is needed. Visual, audible and data communications may also be established, using the communications systems of the various embodiments discussed herein, for example, to convey to the emergency responders a patient's vital signs, and establish visual and audible communications with those on the scene. Thus, it is to be appreciated that the various embodiments discussed herein can be configured, as desired, to provide any desired level of communications capability, and the exchange of varying types of information based thereon, between operators, conductors, maintenance personnel, administrators, passengers and others.

Master Control Station

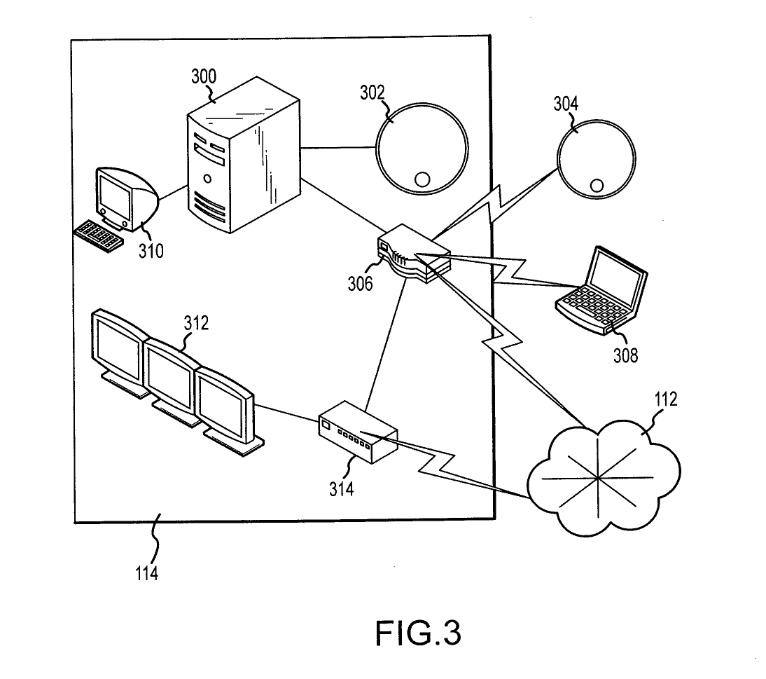

With reference to FIG. 1 and FIG. 3, various embodiments discussed herein may also include a master control station. Back-up and redundant master control stations may also be provided. In one embodiment, the master control station 114 may include one or more servers, such as a system server 300, operating in an open systems architecture. The server 300 may include, for example, one or more processors such as Quad Core Xeon processors manufactured by Intel Corporation of Santa Clara, Calif. Such processors may run any suitable operating system, such as Microsoft WINDOWS Server. It is to be appreciated that other types of processors, sizes, capabilities, numbers of processors, operating systems and manufacturers thereof may be utilized in conjunction with the various embodiments discussed herein.

Each server may be connected to one or more data storage devices, such as data storage devices 306 and 308. A data storage device may be configured into any desired configuration including mirrored configurations, such as those provided by RAID 1 or other configurations. Further any number or type of storage devices may be utilized. Each server may be configured to have hard drives of sufficient speed and storage capacity to meet any given embodiments data storage needs. The storage devices may also be local to the server, as is the case for storage device 302, or remote as for storage device 304. When a system component is remote to another system component, such as storage device 304 with respect to server 300, it is to be appreciated that any suitable communications configurations may be utilized to interconnect the respective system components, including communications networks such as the Internet 112, telecommunications system 104, the world wide web and otherwise.

In at least one embodiment, router 306 suitably interconnects server 300, via one or more communications systems, with remote data storage device 304. Router 306 may also be utilized to interconnect server 300 with one or more remote access devices, such as remote device 310. It is to be appreciated that in certain implementations, remote device 310 and mobile device 116 (of FIG. 1) may be the same device. Such remote device 310 may be utilized by a system administrator to receive transit related system updates, access system operating systems, provide remote control capabilities and otherwise allow an administrator to work remotely. One or more local workstations 310 may be utilized to provide direct access to the server by operators and administrators. That is, remote device 310 and/or local workstation 310 may be utilized by system operators and/or administrators and others to receive, process and disseminate transit relevant information to intended recipients thereof. Such information may be encrypted or otherwise secured utilizing any known or hereafter data encryption and/or access control technologies. Such access control and remote access technologies are well known and are beyond the scope of the present disclosure. Utilizing secure connections, operators and/or administrators may utilize local workstations 310 and/or remote devices 308 to control all aspects of the transit system controllable using a master control station in any given embodiment. Such control may include providing operation instructions to transit system components, such as trains and doors thereon. Such control may also include, but is not limited to, the providing of information relevant to engineers, conductors, passengers and emergency responders. Such information may be provided in any form or format, for example, as a public address announcement. Any number of routers, switches, workstations, remote devices, data storage devices, monitors, video controllers and other telecommunications, control and/or networking components may be utilized in the various embodiments discussed herein to support such remote operations.

In at least one embodiment, the master control station also includes one or more video monitors 312. Such video monitors 312 may be utilized to provide real-time displays of video feeds captured from any transit system related camera, such as those in a train car or located at a station. Video processor 314 and related equipment (not shown) suitably interconnects the monitors 312 with the other transit system components. Such connections can be direct, via the network 112, or indirect for example via the server 300 and related routers 306 and other components. It is to be appreciated that video feeds may be routed to any compatible device connected to the server and operated by a person with suitable authorization. Similarly, video feeds may be suitably from non-transit system cameras and provided by and through the master control station to users suitably interconnected thereto. For example, a video feed from a passenger may be communicated via networks 222, 104 and 112 to a master control station, which then disseminates the images back to a conductor on the train being ridden by the passenger.

While a master control station is described as being utilized in one or more of the various embodiments discussed herein to provide centralized collection, processing and dissemination (and in some instances, control) of transit related information, it is to be appreciated that the master control station is not required in all embodiments. MTs and STs, and/or other processing components, may be configured to separately and/or collectively receive, process and disseminate to various recipients, including those connected via intra-train and inter-train systems, various types of information concerning the operations of the trains with which they are associated and/or the operation of other trains in a transit system. Further, distributed computing systems comprising multiple MTs/STs distributed across multiple trains may be configured to provide a hybrid information reception, processing and dissemination system. Such information may be suitably utilized for various control functions and capabilities, such as door openings and automatic updates.

Modular System Software Architecture

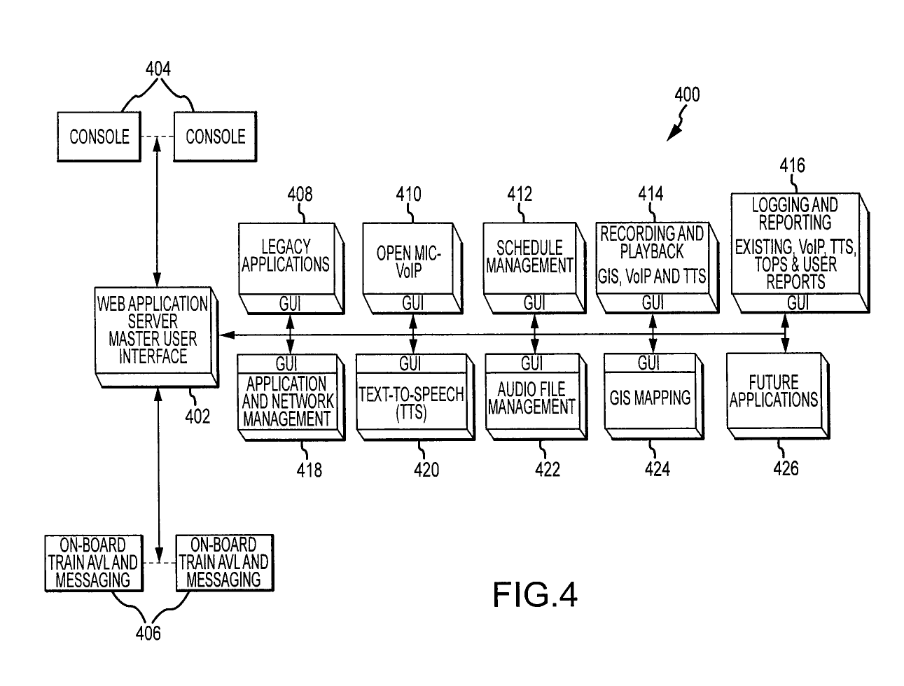

Referring again to FIG. 1, a master control station 114 is also provided in at least one embodiment. The master control station 114 may utilize an open systems architecture which facilitates the use of various software programs and interfaces. In at least one embodiment, such programs and interfaces are modular in nature, such that existing and/or new programs and interfaces may be added, modified or deleted to support present and future system requirements or features. FIG. 4 provides one representation of a modular software architecture 400 and the functional components thereof which may be utilized in at least one embodiment. As shown, such architecture may utilize a web application server module 402 which is capable of mimicking existing transit system tracking systems. The web application server module 402 desirably provides geographic information systems and global positioning systems information for transit operators, and provides a master user interface. Other types of web application server modules, programs, applications and routines may be utilized in other embodiments, as desired.

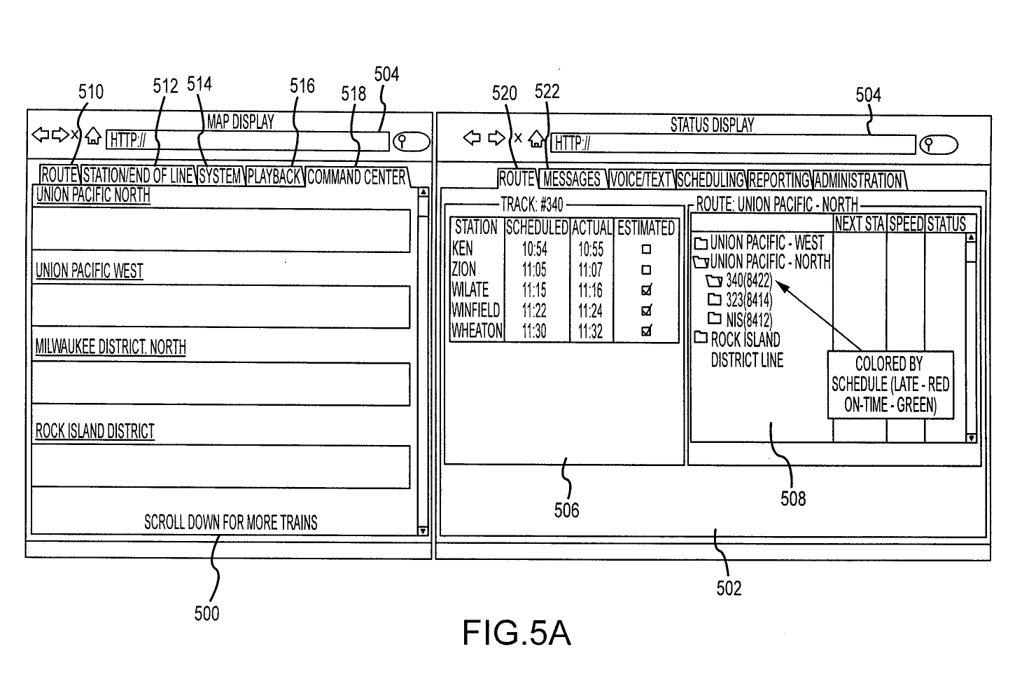

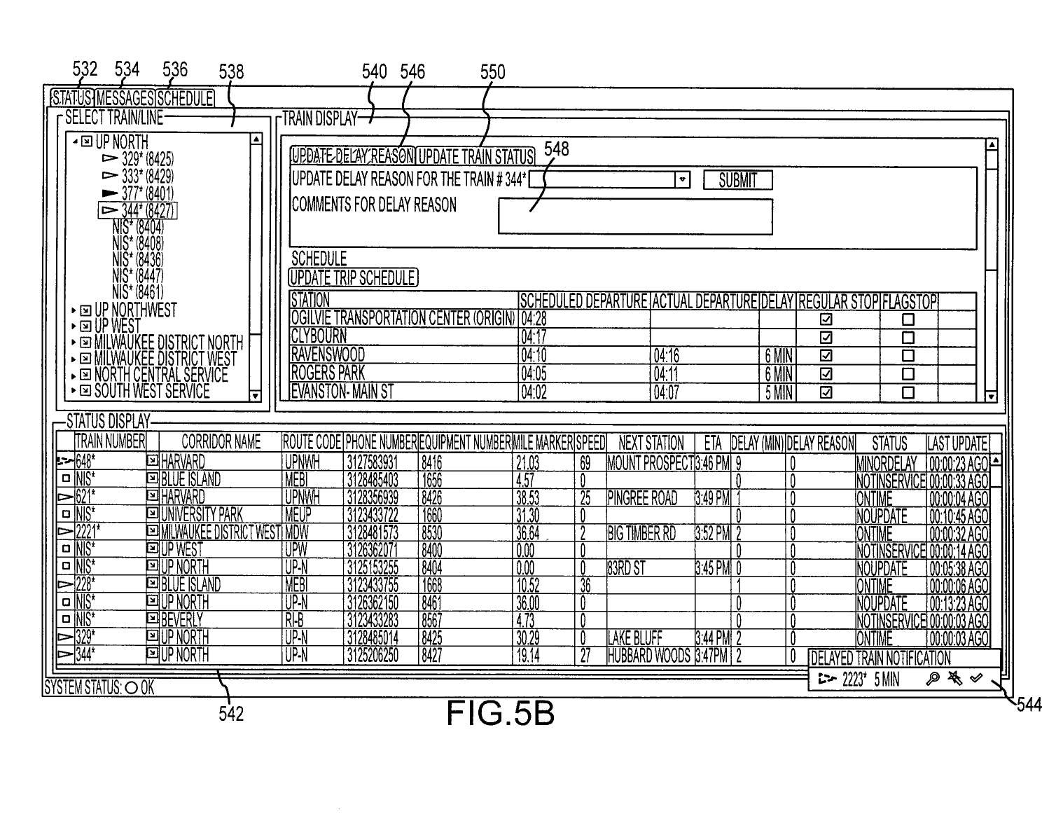

The functional architecture also includes one or more tracking consoles 404 on which a train's position and other transit system information may be monitored by system operators and/or administrators. An embodiment of a display which provides train position status and tracking information is shown in FIG. 5A. With reference to FIG. 5A, for this embodiment, a tracking console 404 may utilize dual display monitors to display two windows, map window 500 and status window 502. Any number of monitors, displays and/or windows may be utilized in the various embodiments. As shown for this embodiment, the tracking console operator is desirably provided the option of accessing a wide variety of information in each window, the information displayed and display characteristics of which may be separately controlled and configured. Each of these windows are illustrated as being provided in a web browser, which each suitably include a navigation bar 504. The status window 502 may also be further separated into two or more panels 506 and 508. Each panel may be configured to provide information relating to multiple files or single files.

Referring to the map window 500 as shown in FIG. 5A, command center tab 518 has been selected and information relating to the operation of a transit system as a whole may be presented. Upon selection of command center tab 518, a representation of each transit line, including the various stations along a line, can be displayed on a line-by-line basis. Status information for each line can be further indicated, or overlaid, on each by showing the location of each train line on a respective line. It should be appreciated that any given line may contain multiple trains and the line-by-line display may be configured, in at least one embodiment to show the relative location of each such train on the line.

Similarly, each line and trains thereon may be individually selected on status window 502. As shown, two panels 506 and 508 may be utilized to display relevant information regarding the status of any given train on any given line, for example the as shown Union Pacific North line. The status of a given train, for example train #340, on this line may be further identified in panel 506, wherein panel 506 provides the operator with scheduled, actual and estimated arrival times of train 340 at various stations. As depicted, an operator would appreciate that train 340 is running behind schedule by two minutes. Further, the system may be configured to provide estimates of a train's arrival time at future stations based upon its arrival time and dwell times and previous stations. Real-time updates may also be provided as a train continues along its line. Desirably, for at least one embodiment, the times at which a train is to arrive at each future station is updated based upon when the train arrives and departs from a preceding station. This real-time updating may be accomplished by the server using a combination of program modules, as shown in FIG. 4, including the schedule management module 412 which is utilized, at least in part, to identify scheduled arrival and departure times, the GIS mapping module 424, which provides real-time position, speed and other movement related information, and various other legacy applications module 408 which may be configured to utilize legacy systems that provide positional information and other information using legacy systems such as track position and speed sensors. Utilizing these modules calculations can be performed which may accurately predict when a given train will arrive at future stations. The information resulting from such calculations is then, desirably, presented to system administrators, conductors, passengers and others using the various communications systems components discussed above including, but not limited to, via mobile devices.

Referring again to FIG. 5A, the operators console may also be configured to display the status of all of the trains on a given line, as shown in panel 508 for the Union Pacific North train line. The status of each train may be suitably indicated by any graphical technique desired, such as by color, bold, shadow, italics, underline or otherwise. Open file folder icons and other graphical elements may be utilized to convey to the administrator which train, of a given line, scheduling and status information is being displayed, for example in panel 506. Scroll bars, finger swipes, mouse clicks, double taps, roller wheels and other well known graphical control techniques may be utilized to facilitate an operator's navigation, selection, de-selection and use of information related to one or more trains under their purview at any given time.

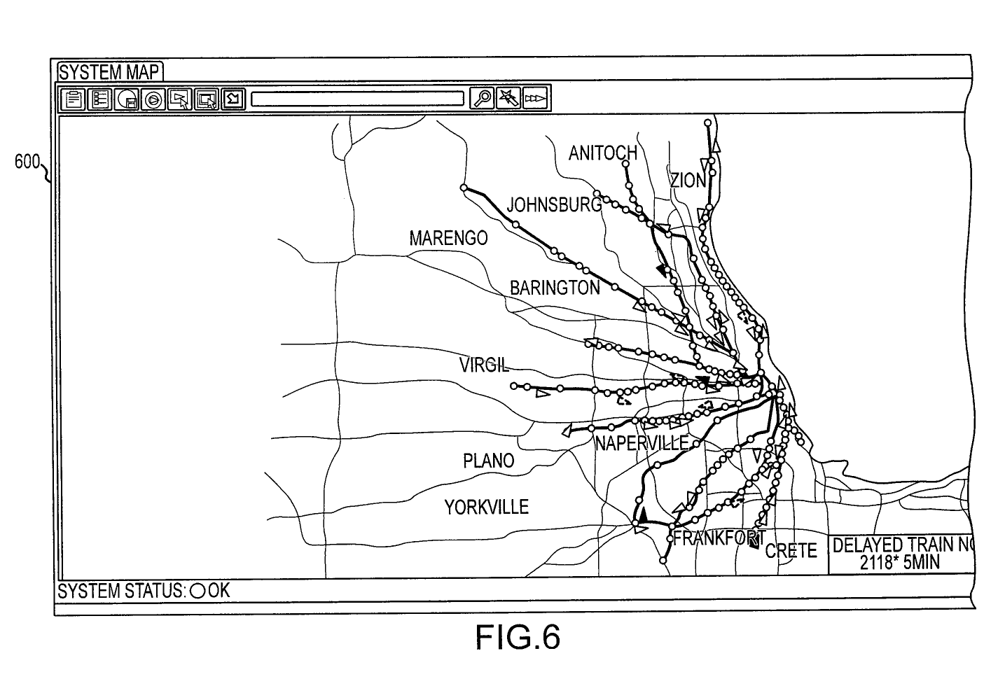

As further shown in the map window 500, various other forms of map based information may be reviewed by an operator. Examples of such map based information include route information, which may be selected by route tab 510. As shown in FIG. 6, upon selection of the route tab, detailed route information is desirably displayed in the map window 600. Such information may include line configurations, including branches that can be merged into a single line. After a branch is merged, a single line can be displayed, showing the route a train will take along a line from destination to destination. Further, routes can be updated and reconfigured on a real-time and as needed basis, for example, when a previously selected section or branch is no longer optimal or available, for example due to a stalled train on the section or branch. That is, using tracking console 404, a system operator may reconfigure transit system operating parameters as desired.

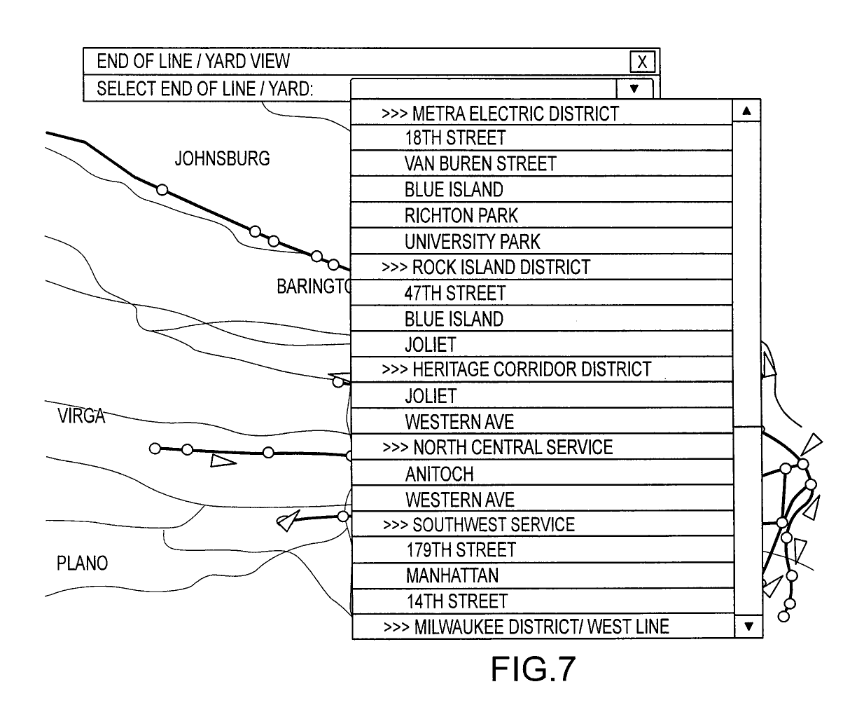

Referring again to FIG. 5A, map window 500 also includes, in at least one embodiment, station/end of line tab 512. Upon selection of this tab 512, information regarding the various stations of a line may be presented, as shown in FIG. 7. The End of Line/Yard Tool 700 allows the user to zoom in very closely to areas where trains are normally stored. This is useful for maintenance personnel looking for a particular train car. The End of Line/Yard View drop down list features three arrows next to some of the items. These may be used, for this embodiment, to indicate locations that are not selectable items but rather a corridor grouping where a storage area can be found.

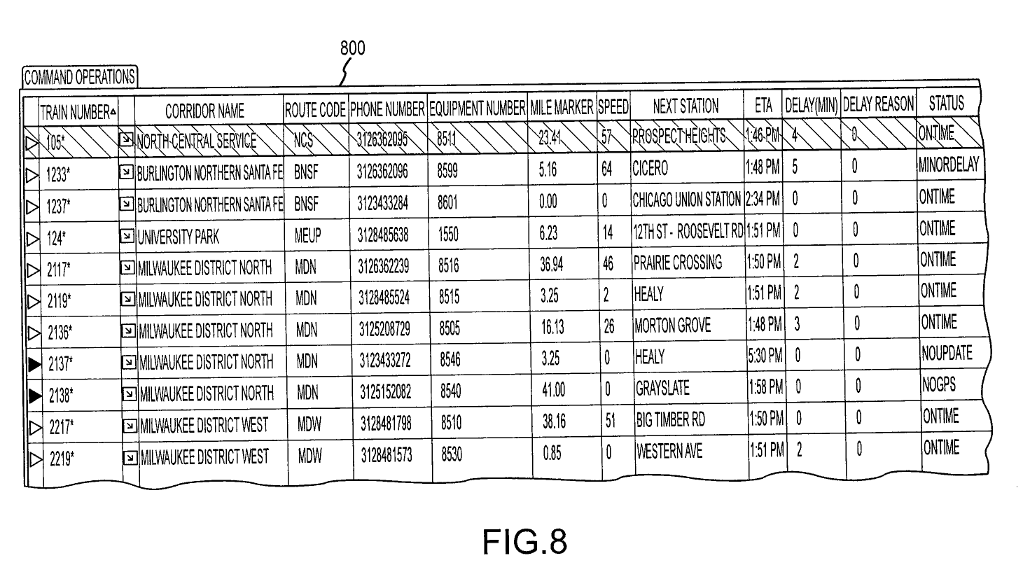

Referring again to FIG. 5A, map window 500 also includes, in at least one embodiment, system tab 514. Upon selection of this tab 514, information regarding the transit system as a whole may be presented, as shown in FIG. 8. In at least one embodiment, the system view may be presented in a Command Operations Module 800 or similar module that provides a view of all the trains in any given system. The train grid concept may presented and manipulated as desired. For example, trains may be listed in columns that can be sorted, resized, added, deleted, relocated or otherwise manipulated to provide a customizable screen. Exemplary subjects presented may include train number, corridor number, route code, phone number (for example, to a conductor or engineer), equipment number, mile marker (indicating current location), speed, next station, estimated time of arrival, delay time, delay reason, status and other information. Actions performed using this module may be linked to the other system modules. For example, using a “zoom to train” function, information relating to a selected train may be presented uniquely, in greater detail, on an open system map and otherwise.

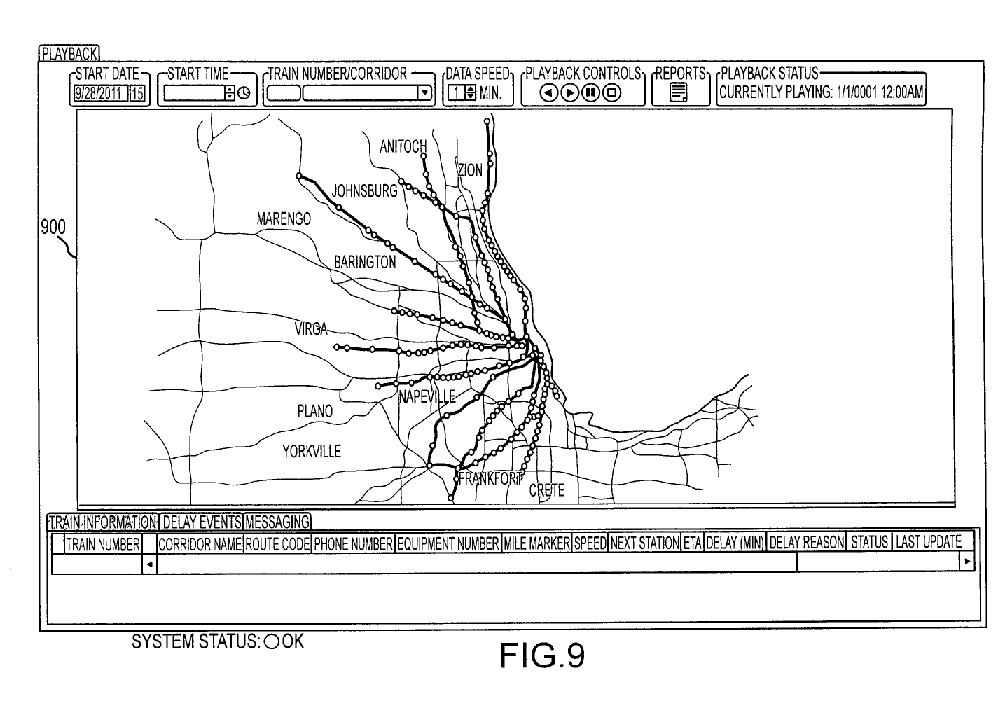

Referring again to FIG. 5A, map window 500 also includes, in at least one embodiment, playback tab 514. Upon selection of this tab 514, information regarding the playback of one or more recorded system components may be presented, as shown in FIG. 9. For example, a Playback module 900 may be presented and used to replay system activities. In at least one embodiment, the playback module enables a system operator to review past system events. In one embodiment, events occurring as many as 90 days in arrears may be reviewed. Other embodiments may present longer or shorter (if any) playback windows. Also, for at least one embodiment, all, certain and/or selected system, train specific, group specific and/or other designations of activities may be recorded and/or logged into the system database. Using the playback module, a system operator may select a past event(s) and have the data associated therewith presented in any desired order (for example, chronological). Snapshots, specific sequences, triggered events or other classifications of past system information may be presented as desired. The playback module may be utilized to assist with various training, evaluation, trouble shooting, trending and other purposes. For example, when used for trouble shooting, the playback module may be utilized to find and/or provide answers to questions, such as what was the trouble? When was it known? And, what was done about it?

Referring again to FIG. 5A, status window 502 may also contain numerous tabs that may be selected by a system operator and/or administrator and provide more granular status and control tools. As shown in FIG. 5A, status window 502, in at least one embodiment, includes “route” tab 520. As discussed above, route tab 520 opens one or more panes, such as panes 506 and 508, on which information pertaining to a transit line or route and the trains operating with respect thereto can be identified.

As shown in FIG. 5B, in another embodiment, status information may be presented as shown. In this embodiment, an operator may be presented with various tabs, such as status tab 532, messages tab 534 and schedule tab 536. Also, various panes may be presented including line/train selection pane 538, train display pane 540, and status display pane 542. Notification windows may also be presented, on a pop-up or other basis, such as notification window 544, which in this embodiment may be configured to present a notification when a given train on a line is delayed. It is to be appreciated that the notification window 544 may be configured by system administrators and/or operators to appear whenever a given train is delayed by any amount, including by pre-set amounts or real-time set amounts. As shown, various icons may be provided in such notification window 544 to enable a system operator to dig more deeply into the causes of the delays. Such investigation may include bringing up various cameras and other audio/video devices, contacting train engineers or conductors or taking other actions.

FIG. 5B also provides, in this embodiment, the before mentioned select train/line pane 538. This pane 538 may be configured to enable a system operator to access information on the select few of the various lines on a transit system for which the operator is responsible. In other embodiments, system operators may be able to view but not take action with respect to all lines and trains in a transit system, while system administrators may possess global permissions enabling them to view and take actions with respect to all lines and trains in a transit system. Hence, it is to be appreciated that the various embodiments may be configured to utilize permission based access and control systems to determine what information and actions any given operator, system administrator or other person having access to the master control station features and functions may take with respect to any given line and/or train thereon.

FIG. 5B also provides, in this embodiment, the before mentioned train display pane 540. This pane 540 may be configured to present more detailed information to a system operator regarding the operations of a given train and to allow the operator to update a trains status and schedule accordingly. For example, the update delay reason button 546, when selected desirably presents a text entry field 548 providing drop down designators and customizable text entry for explaining the reason a given train is delayed. The reasons for a train delay may be obtained by the operator from a train's engineer, conductors and/or sensors provided thereby, for example, door sensors. Such information may be utilized for internal trending, future schedule generation, training and other purposes. Similarly, the update train status button 550, may be configured for selection by an operator to designate a status for the train, for example, “delayed” or “on-time.” Other status indicators may be utilized as desired for any given implementation of the various embodiments discussed herein. Such status information may be communicated across the transit system to users of the same, including engineers, conductors, passengers and others via any suitable communications medium and/or device including, but not limited to, message boards and mobile devices.

FIG. 5B, in this embodiment, may also be configured to include the status display pane 542. This pane 542 may be configured to present the status of multiple lines and/or trains in tabular, list, graphical or other formats, with a tabular format being depicted in FIG. 5B. As shown, various information about a train may be presented including the train's name, the corridor or line on which it is operating, a route code, a phone number to the engineer, the equipment used for the cab, where it is on the route, the speed, next station, ETA, delay, delay reason, status, last update, and other information. More or less information may be presented on this pane as desired for any given embodiment.

Referring again to FIG. 5A, status window 502 may also include, in at least one embodiment, a messages tab 522. Upon selection of this tab 522, information regarding messages that may be presented to passengers, engineers, conductors or others may be identified. In at least one embodiment, via tab 522 system operators are presented options for accessing tools provided by the audio file management module 422 (FIG. 4). Such tools may include selecting one or more pre-recorded audible messages. Messages may be combined into composite messages, as desired. In at least one embodiment, messages tab 522 enables system operators to provide selected, automated announcements to individual train cars, consists, trains, lines, platforms, or even system wide. For example, a message providing that all trains are running on a reduced schedule might be presented system wide, including to users of mobile devices. Contrarily, a message that a certain car or cars of a train would not arrive adjacent to a platform at a given station, and passengers desiring to depart the car at such station need to proceed to another car, may be provided to only the effected car or cars and conductors associated with such car(s). Messages communicated to transit system components may be logged and saved for later review by recording and playback module 414 (FIG. 4). Saved messages may be kept for any given time period so as to be immediately available, for example, for thirty days in a rolling log. Longer term back-up of messages to archives may also be provided, as desired for any given embodiment.

Further, messaging may also be provided on a real-time basis using text to speech, speech compression protocols, voice over internet protocol, and other protocols. Referring again to FIG. 5A, voice/text tab 524 may be provided, in at least one embodiment, to enable system administrators to communicate such real-time messaging. Upon selection, voice/text tab 524 suitably calls up for an operator's use the tools of text to speech module 420 and/or open microphone module 410 (FIG. 4). For at least one embodiment, the tools provided voice/text tab 524 may include inputting textual characters as a data stream, for example using a keyboard. Upon entry of such textual characters, the message is suitably communicated to the designated location, for example, car, consist, train, station, line or other transit system component(s), for presentation thereby. If any given designated location for receiving the message only includes visual presentation devices, such as LED boards, then the message may remain in a text based format. Similarly, if any given designated location contains only audible messaging capabilities, for example via one or more loud speakers, then the message is suitably converted from a textual format to an audible format. Such conversion may occur at the master control station, using text to speech module 420 (FIG. 4) or at the designated receiving location(s) using comparable modules. Further, such module 420 may be configured to translate a given message into multiple languages. Similarly, open microphone module 420, may be utilized to provide spoken messages to desired recipients. Such messages may also be suitably converted into visual messages and/or translated into multiple languages and output to recipients as audible and visual messages, as any given receiving device(s) so support. As such, for certain embodiments reaching multiple transit system components, the system may be configured such that a system operator using a keyboard, microphone or other input device can input a message that is suitably converted into the format(s) supported by any given receiving device.

In at least one embodiment, the audio file management module 422 (FIG. 4) may also or alternatively be configured to control the timing and prioritization of messages. For example, a message announcing an emergency situation may be prioritized automatically over a message announcing the next arriving station. Lower priority messages can be silenced or queued automatically or as desired by a system administrator, operator, conductor or other person responsible for a given car, consist, train, line or other system component.

Messaging may also be automatically controlled, under system operator supervision, based upon positional, time, last station, mile post and other information. In at least one embodiment, audio file management module 422 suitably interacts with GIS mapping 424 and/or legacy applications 408 modules to coordinate when messages are automatically presented.

Further, given the two-way communications capabilities of the various embodiments discussed herein, messages to system administrators, operators, engineers, conductors, emergency responders and others may also be processed by text-speech module, open microphone module 410 and other system components such that communications capabilities can be supported between any given transit system users, in any desired language and using any desired communications format (audible, visual, or otherwise). Thus, for example, a Japanese speaking passenger using a Chicago bound train could communicate with, for example, an English speaking system operators, engineer, conductor, or emergency responder via an intercom in a car that is suitably connected to the master control station, with a suitable return communications path existing with the other participant to the conversation.

Examples of messages that may be communicated using transit system components and the modules provided via the master control station include: end of line, express, special, temporary delay, temporary delay of X minutes, please remain on-board the vehicle, vehicle failure—please exit at next station, please evacuate vehicle, and other forms of public service announcements. In at least one embodiment, a pre-determined set of messages are communicated to each MT and ST and stored locally thereby. In certain embodiments and at certain times during operations thereof, an external communications link between a given train and the master control station may not exist. As such, for at least one embodiment, messages may be pre-cached by a MT and/or ST and may be triggered automatically, by operators, engineers, conductors, or others. Pre-cached messages may be updated via the external communications link as desirable and when possible.

As discussed above with respect to messages tab 522, communications arising via use of voice/text tab 524 or which otherwise utilize any of the transit system communications components may be recorded and stored using recording and playback module 414 (FIG. 4). Logging and reporting of messages and other transit related system parameters may be provided by logging and reporting module 416. Such module 416 may be used to create messages, reports and other information in any desired format including any combination of audio/video and/or data files.

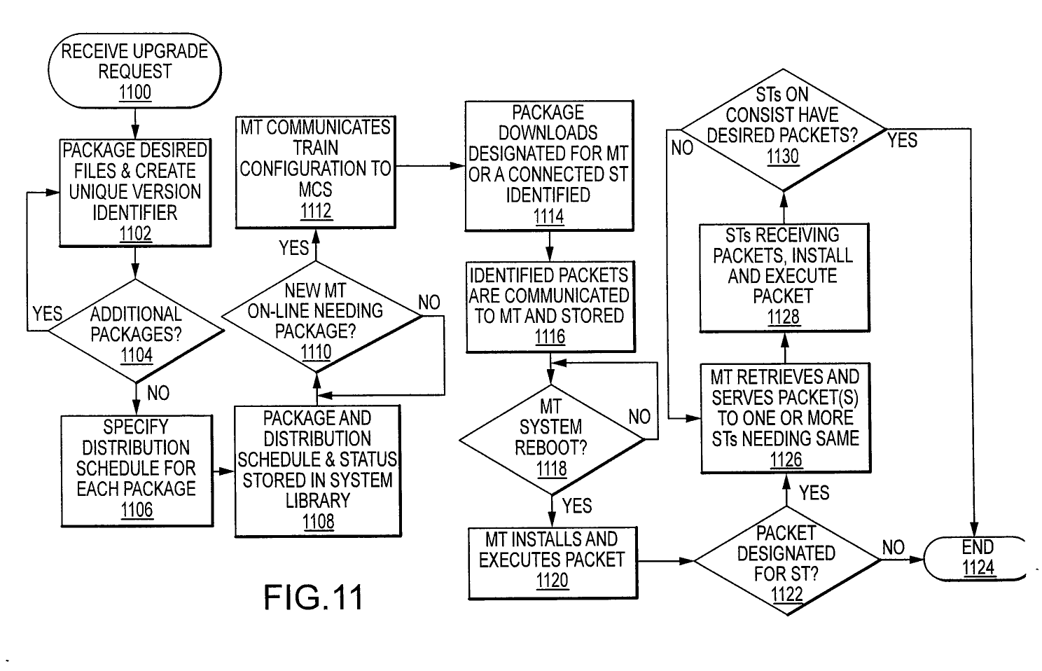

Referring now to FIG. 5B, in accordance with this embodiment, a messages tab 534 may be provided. Upon selection of this tab 534, another embodiment of a messaging window 552, as shown in FIG. 11B may be presented to an operator. This window 552 may be configured to include a trains listing pane 554 in which lines and trains thereon may be identified and selected. The window 552 may also include a messages pane 556 in which messages may be input as free text, upon selecting free text tab 558, into a message field 560. The text of any message may also be converted to speech, as described above in conjunction with other embodiments, and presented phonetically in the phonetics field 562. The tone and verbal characteristics of such converted speech may also be controlled, for example a first female voice may be selected, using speaker drop down 564, and utilized for the delivery of the message.

Upon selection of the message wizard tab 566, a message wizard may be utilized. In at least one embodiment, the message wizard provides small, pre-defined phrases that may be combined with other existing, or real-time generated words or phrases, to construct a compound message. For example, an existing phrase, such as “the next station is”, may be combined with a station identifier, for example, the “5^{th} and Market” to create a compound message of “the next station is 5^{th} and Market.” Such compound messages may be desired, for example, when a train is deviated from a standard route for which pre-canned messages have not already been developed.

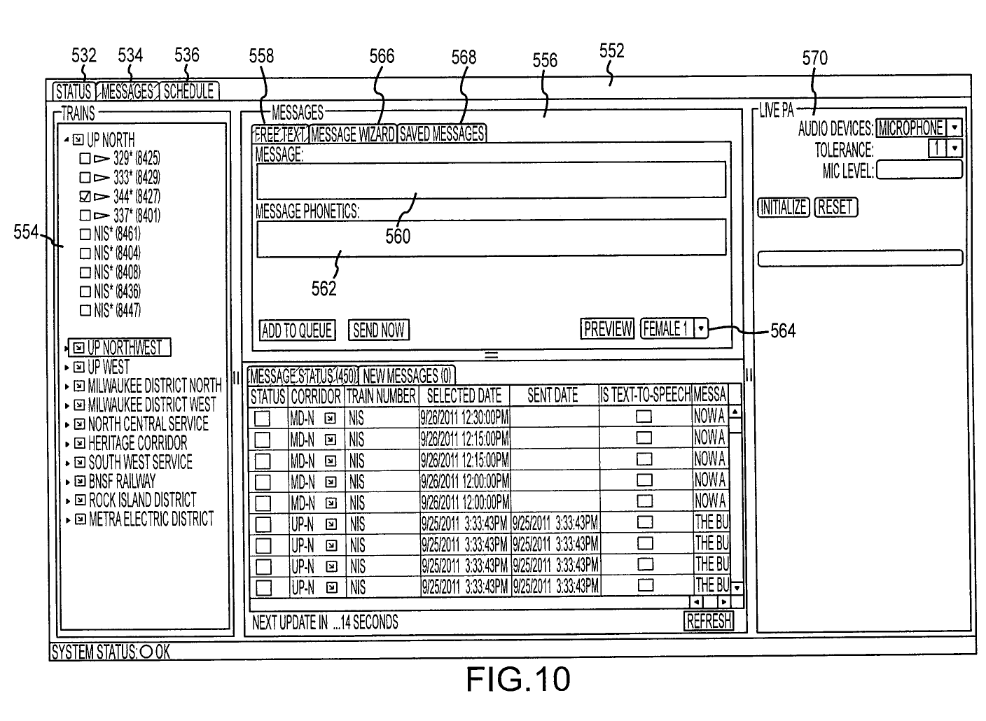

An option to access saved messages may also be provided in an embodiment. As shown in FIG. 10, the save messages tab 568 enables a system operator to select existing messages for scheduled and/or real-time presentation to transit system users. For example, in response to a mechanical or other non-emergency situation which prevents a train from continuing upon its route, a system operator may select an pre-recorded message informing passengers that an emergency situation has not arisen, but, due to mechanical problems all passengers must exit the train at the next station. The ability to provide and utilize saved messages enables system operators to efficiently and timely provide the desired notifications to users while also freeing them to focus upon the issues giving rise to the train, line or system level disturbance.

The embodiment shown in FIG. 10 may also be configured to provide live public address capabilities via the features and functions provided on the live PA pane 570. As discussed above for other embodiments, a system operator may utilize a microphone or similar audio reception device to provide verbal messages directly to cars, trains, lines, stations, mobile devices and other users of the transit system. Live PA pane 570 provides on example of a system embodiment facilitating such real-time verbal messaging.

Referring again to FIG. 5A, status window 502 also includes, in at least one embodiment, scheduling tab 526. Upon selection of this tab 526, information regarding the scheduling of trains, lines and system wide may be administered. More specifically, in at least one embodiment, a system operator may invoke the tools, features and functions of schedule management module 412 (FIG. 4). Such tools, features and functions may be configured to enable a system operator to provide real-time control of a trains, a lines or a systems schedule. Such real-time control needs may arise, for example, in the case of inclement weather. Further, these scheduling tools, features and functions may also provide system operators with the ability to provide future scheduling options to address future transit system needs, such as the addition of new lines or the providing of additional cars and/or trains on existing lines during special events (e.g., during the Cubs World Series appearance). Such scheduling tools may utilize data obtained by logging and reporting module 416, such as passenger load counts, station loads, station dwell times and other information to determine, car, consist, train, line, stations and system level needs. Further, the schedule management module 412 may be configured to automatically utilize audio messages, such those provided by audio file management module 422, to ensure the proper message queue and selections are available on any given train at the desired time. Thus, it is to be appreciated that a system administrator may utilize various tools, features and functions to real-time and in the future schedule and control transit system resource utilization levels, while also ensuring that the proper messaging is accomplished at the desired transit system level, i.e., car, consist, train, line, station and/or system wide.

Referring again to FIG. 5A, status window 502 also includes, in at least one embodiment, reporting tab 528. Upon selection of this tab 528, information regarding the past performance of cars, consists, trains, lines, stations and/or system wide may be obtained. For at least one embodiment, reporting information includes the above discussed messaging reporting. In at least another embodiment, reporting information may also or alternatively include performance information and other operations related information. When selected, tab 528 may invoke the tools, features and functions of logging and reporting module 416 (FIG. 4). Conductor trip reports may also be input and accessed using this tab 528. Such reports may be input by a conductor using any available terminal, including those on-car, on-station, at a depot or master control station, and/or provided via mobile devices. Conductor reports may also be generated automatically by system components. Such reports may utilize, for example, information provided by GIS mapping module 424 to determine station dwell times, load factors, schedule adherence and other factors.

Logging and reporting module 416, and associated reporting tab 528, may also be utilized to collect, present and assist in analyzing maintenance and other infra-structure related parameters associated with a car, consist, train, line, station or other transit system related component. Such information may be provided on an as-desired, routine (e.g., daily), and/or emergency basis to recipients. For emergency reporting, recipients may be specified in advance or added real-time. Such recipients may include emergency responders. Practically any type of information or parameter may be logged, tracked, monitored and/or reported using the logging and reporting module as utilized in conjunction with the various embodiments discussed herein.

Referring again to FIG. 5A, status window 502 also includes, in at least one embodiment, administration tab 530. Upon selection of this tab 530, information regarding the administration of the master control station and other system wide components may be accessed. Upon selection of tab 530, application and network management module 418 (FIG. 4) may be invoked. System administration may include common administrative functions, such as specifying system user's roles, responsibilities, permissions, reporting and similar functions. System administration may also include the addition of future applications, as represented by future applications module 426, and the deletion of existing or legacy applications, such as those represented by legacy applications module 408. Further, the administration tab 528 and associate management module 418 may be utilized to generate one or more packages that specify program files, operating system files, driver files, scripts, audio messaging and scheduling information. Such packages are provided to affected transit system components, such as trains and stations affected, for example, by a schedule change and also to passengers (who desirably receive an advance notification of the schedule change). One process by which packages are created and communicated to various system components is illustrated in FIG. 15.

Referring now to FIG. 11, one embodiment of a process for creating and communicating a package of information to one or more transit system elements is depicted. As shown, this embodiment generally begins with a system administrator, or an operator, receiving an upgrade request, as per Operation 1100. The upgrade request may relate to any element of software (including executable software), or data (such as scheduling data and/or messaging data) utilized by a transit system component(s). Such components can be device specific, for example, an ST in a given car, system wide or at any level of dissection in-between.

Upon receiving the upgrade request, the system administrator packages the desired files together and creates a unique version identifier for the package, as per Operation 1102. In at least one embodiment, the version identifier specifies a version timestamp, but, other naming conventions for a package of data may be utilized, as desired for any given embodiment. A verification is then made as to whether additional and/or multiple packages are to be communicated to any given system component(s), as per Operation 1104. If so, suitable packaging and versioning is accomplished, as per a repeat of loop 1102 to 1104 until all desired packages have been created.

Once all desired packages are created and versioned, the process may continue with the specifying of a distribution schedule for each package, as per Operation 1106. In at least one embodiment, any given package may be uniquely scheduled including the maximum number of concurrent upgrades that may be communicated to any given transit system component. Similarly, a date range for package delivery, a number of repeat attempts, or other delivery parameters may be specified. In at least one embodiment, for a train, a MT is designated for the upgrade and STs, which may vary from train to train by day, time of day or otherwise, are not specifically designated.

Packages and distribution schedules are suitably stored, as per Operation 1108, and the status of each package is monitored. A package's status may include a partially upgraded status, as may occur when communications with an intended MT recipient of a package are interrupted and a complete download of the package by the intended MT recipient is not achieved.

As per Operation 1110, when an MT comes on-line, a determination is made by the master control station as to whether the MT is designated to receive one or more packages for itself or for any of the STs on the given train's consist. The system may accomplish this by querying the system library for any packages or partial packages which designate the MT and/or a given ST on the consist. To facilitate this updating function, each MT, when it comes online, is desirably configured with respect to its line, the operating number, and the number of cars, and STs provided therewith, associated or to be associated with the train. The MT suitably communicates such configuration information to the master control station, as per Operation 1112.

As per Operation 1114, those package downloads, including uncompleted downloads, are then identified by the master control station for communication to the MT and any STs connected thereto. Next, as per Operation 1116, those packets identified for communication to the MT, or for communication to an ST connected to a given MT, are communicated over the external communications link. In at least one embodiment, previously commenced, but interrupted, downloads of one or more packets are resumed at a place of logical resumption, which in certain embodiments may include re-initiating a download from a beginning. In certain other embodiments, a packet download may resume mid-packet. In at least one embodiment, packets are communicated from the master control station to the designated MT utilizing a non-deterministic network such as one supported by the use of the User Datagram Protocol (UDP). In at least one embodiment, the receipt of a packet communicated using UDP is desirably confirmed by the designated MT. Should the designated MT not confirm receipt of the packet, the packet may be communicated up to ten (10) times. After ten (10) unsuccessful transmissions, an error flag is desirably set and a system administrator may troubleshoot the connections between a given MT and the master control station. In other embodiments, other data transfer protocols may be utilized in conjunction with non-deterministic and/or deterministic networks examples of such protocols include, but are not limited to, the Transmission Control Protocol (TCP), Stream Control Transmission Protocol (SCTP) or other transport layer protocols. Further, it is to be appreciated that the packets may utilize various other protocols along the various hierarchies of the Internet Protocol Suite (or stack), such protocols are well known in the art. Once a packet is received by an MT, it may be stored for later execution or executed immediately, depending upon the packet's priority and type.

In at least one embodiment, as per Operations 1118 and 1120, a received packet is executed by an MT when the MT undergoes a scheduled, forced or manual reboot of its operating systems. It is to be appreciated that certain packets may be designated such that upon being received by an MT, they automatically trigger a reboot and updating of the MT. The install and execution of packets received by an MT may also be triggered manually by a system administrator, operator, engineer, or conductor, as the case may be. Reboots, installs ande execution of packets may also be time based, for example, designated to occur each day when a train car, containing the MT, is off-line. Likewise, it is to be appreciated that during operations of a train car containing an MT, installation and execution of emergency packets may be delayed until the car is “off-line,” stopped at a station or otherwise in a location at which a packet can be safely installed and executed without disrupting critical operations of the MT, the train and/or the transit system.

Next, in Operation 1122, a verification is conducted by the MT as to whether any of the STs require a packet update and/or whether any of the previously received packets are designated for an ST. If no such packets are needed or designated, the process ends, as per Operation 1124. If a packet is needed by an ST, the process continues, as per Operation 1126, for at least one embodiment, with the MT operating as a server with respect to each of the STs connected thereto. When operating as a server, the MT coordinates requests for packets for STs with the master control station. The MT also controls the communication of the packet along the train's consist, or via the wireless intra-train network, to the designated ST. In at least other embodiment, each ST communicates directly with the master control station to retrieve, or be pushed, any needed packets. In this configuration, the MT effectively operates as a router providing communications connectivity between the ST and the master control station.

As per Operation 1128, the process continues with each ST receiving those packets designated for it, installing the packet and executing the packet. In at least one embodiment, all STs on a given consist may be updated by an MT at the same time, thereby ensuring all train system components are operating off of the same packet of software codes, routines, messages and other protocols. In at least one other embodiment, each ST may be configured with a unique packet. Such packet may be based upon the capabilities, features and/or functions the given car provides in the train. For example, an ST for a baggage car might not be updated with messaging intended for a car providing dining or sleeping facilities. Further, STs may be updated with packets during any desired time, as dictated by system operators and procedures. In at least one embodiment and/or implementation of an embodiment, packets are installed and executed during a regularly schedule reboot of the ST. In other embodiments and/or implementations thereto, packets are installed and executed on a manual, periodic, immediate or other time basis.

As per Operation 1130, the process desirably continues with the retrieval, serving, install and execution of packets until each ST in a train is configured with the then desired packets, at which instance the process terminates (as per Operation 1124).

The foregoing description of one embodiment by which a packet of software programs, routines, messaging, scheduling and other information may be communicated and executed across a train and its consist, may also be executed across train lines, transit systems and, in certain embodiments, across multiple independent transit systems. For example, emergency packets may be communicated to all transit system components by the U.S. Department of Homeland Security, when a national emergency situation were to arise.

In the present disclosure, various of the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

Various elements of the described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to: a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While several embodiments have been discussed, it will be appreciated by those skilled in the art that various modifications and variations are possible without departing from the spirit and scope of the disclosure set forth herein. For example, the various embodiments herein may be utilized to provide control and messaging features for fleets of busses. Similarly, it may be used in other fields and endeavors wherein multiple system components share a commonality in form or function, but are independently or quasi-independently operated. Hence, the described embodiments are, in all respects, to be considered only as illustrative and not restrictive. The scope of the claimed subject matter is therefore indicated by the appended claims rather than by the foregoing description. All changes which come within the meaning and range of equivalency of the claims are to be embraced within their scope.

1. A system for updating at least one train of a transit system comprising:
at least one train position determining device, configured to determine a position of a train having one or more cars and to output one or more train position signals;
at least one intra-train communications system, communicatively connected to the at least one position determining device, and further comprising at least one master terminal, wherein the master terminal is configured to receive and store one or more packages of information originating from a master control station, receive the one or more train position signals from the at least one train position determining device, and present one or more messages to one or more users of the train, wherein the messages are obtained from the one or more packages of information; and
at least one inter-train communications system device, in communication with the master terminal, wherein the inter-train communications system device is configured to receive and communicate the one or more train position signals to a master control station, receive the one or more packages of information from the master control station and communicate the one or more packages of information to the master terminal.

2. The system of claim 1, wherein the master control station generates the one or more packages of information based upon a determination that the train is delayed with respect to reaching a given location along a transit route at a given time, as determined based upon one or more train position signals received by the master control station, the one or more packages including updated schedule information; and
whereupon receipt of the one or more packages, the master terminal accordingly updates any previously stored schedule information.

3. The system of claim 2, wherein the one or more packages include at least one message indicative of the updated schedule information, and whereupon receipt of the one or more packages, the master terminal presents the updated schedule information to one or more users of the train.

4. The system of claim 3, wherein the one or more packages are communicated by the master control station to at least one station platform at which the train is scheduled to stop.

5. The system of claim 1, wherein the intra-train communications system further comprises:
at least one satellite terminal, located in a second car of the train and communicatively connected to the master terminal utilizing a consist existing between the first car and the at least one second car.

6. The system of claim 5, whereupon receipt of the at least one package of information, the master terminal determines whether the package contains information relevant to the satellite terminal, and if so, communicates the relevant information across the consist to the satellite terminal and wherein the at least one satellite terminal is configured to process one or more received packages to extract and present at least one message to one or more users of the second car.

7. The system of claim 6, wherein at least one of the at least one message presented to the one or more users of the second car provides information including at least one of scheduling information and emergency response information.

8. The system of claim 7, wherein the at least one message presented is generated by an operator of the master control station utilizing at least one of a pre-saved message, a message wizard generated message, a free text generated message, a text to speech generated message, a speech to text generated message, a translated message and an audible message.

9. The system of claim 1, wherein the package of information includes at least one of scheduling information, audio file information, messaging information, operating system information, driver file information, scripting information, and program file information.

10. The system of claim 6, wherein the package of information includes at least one of scheduling information, audio file information, messaging information, operating system information, driver file information, scripting information, and program file information.

11. The system of claim 1, wherein the at least one train position determining device is configured in a first car of the train.

12. The system of claim 11, wherein the at least one train position determining device further comprises a global positioning system receiver.

13. The system of claim 5, wherein the intra-train communications system further comprises at least one secondary communications network communicatively connecting at least one satellite terminal to the master terminal.

14. The system of claim 13, wherein the at least one secondary communications network further comprises a wireless communications network.

15. The system of claim 14, wherein the wireless communications network communicatively connects at least one user in a car of the train with at least one cloud based service provider via the at least one inter-train communications system device.

16. The system of claim 1, wherein the inter-train communications system device is configured to establish a communications connection with at least one cloud based service provider.

17. The system of claim 1, wherein the inter-train communications system device is configured to establish a communications connection with the master control station utilizing a wireless communications system.

18. A method for updating information utilized by at least one of a master terminal and a satellite terminal positioned in a car of a train comprising:
receiving, by a master terminal, a package of information generated and communicated by a master control station, wherein the package of information is relevant to at least one or more cars of a train;
storing the package of information in a database accessible by the master terminal;
upon a rebooting of the master terminal, installing and executing the package, wherein the installation and execution of the package includes determining whether any element of the package is designated for at least one satellite terminal of the train; and
when an element of the package is designated for at least one satellite terminal of the train, serving those elements of the package designated for the at least one satellite terminal to each of the at least one satellite terminals so designated.

19. The method of claim 18, wherein the package of information is generated by the master control station based upon current configuration information, communicated to the master control station by the master terminal, for at least one of the master terminal and the at least one satellite terminal, and based upon such current configuration information one or packages of information are designated by the master control station for communication to the master terminal.

20. The method of claim 19, wherein the package of information is generated by the master control station based upon real-time position information communicated by the master terminal

21. The method of claim 20, wherein the package of information includes at least one of scheduling information, audio file information, messaging information, operating system information, driver file information, scripting information, and program file information.

22. The method of claim 21, wherein any element of a package designated for a satellite terminal is communicated by the master terminal to the designated satellite terminal using a consist existing within the train.

23. The method of claim 21, wherein any element of a package designated for a satellite terminal is communicated by the master terminal to the designated satellite terminal using a wireless communications network.

24. The method of claim 18, wherein the package of information is communicated by the master control station to the master terminal over a non-deterministic network.

25. The method of claim 24, wherein the communication of the package of information by the master control station is repeated at pre-determined number of times until a confirmation of receipt is received from the master terminal.

26. The method of claim 25, wherein the pre-determined number of times is ten and upon not receiving a confirmation of receipt of the package by the master terminal after ten transmissions a communications failure notification is provided to a system operator.

27. A method for establishing communications between one or more cars of a consist comprising:
establishing a first identifier associated with a first terminal located in a first car of a consist;
establishing an electrical communications connection between the first terminal and a second terminal located in a second car of the consist;
communicating, using the electrical communications connection, a wireless network identifier from the first terminal to the second terminal; and
accepting, at the first terminal, a request from the second terminal to establish a wireless communications link between the first terminal and the second terminal using one or more wireless network signal characteristics associated with the wireless network identifier;
whereby upon acceptance of the request from the second terminal by the first terminal a wireless communications connection is established between the first terminal and the second terminal.

28. The method of claim 27, wherein prior to communicating the wireless network identifier from the first terminal to the second terminal, the method further comprises:
receiving, at the first terminal, an identification of the second terminal
verifying the identification of the second terminal; and
when the verification of the second terminal is not verified, identifying an error condition.

29. The method of claim 28, wherein the error condition identifies that a car, associated with the second terminal is not designated for the consist and has been connected to the consist.

30. The method of claim 28, wherein the identification of the second terminal indicates to the first terminal that the second terminal can be configured as a master terminal and the method further comprises:
determining if two or more terminals configurable as a master terminal have identified themselves on the consist; and
if two or more terminals configurable as a master terminal have been identified, determining a priority between each of the terminals identified as configurable as a master terminal.

31. The method of claim 30 wherein the determination of priority further comprises determining which of the identified terminals configurable as a master terminal satisfy at least one challenge routine.

32. The method of claim 31 wherein the at least one challenge routine includes an identification and ranking of at least one terminal parameter selected from a group consisting of a version of software installed onto the terminal, a challenge priority setting, a train car number, a position of a car associated with the terminal in the consist, a random number, and a unique network identifier.

33. The method of claim 27 wherein the electrical communications connection between the first terminal and the second terminal is established using an audio communications link established between the first car and the second car.

34. The method of claim 33 further comprising, establishing a second electrical communications link between the first terminal and the second terminal.

35. The method of claim 34 wherein the second electrical communications link utilizes a power line connection between the first car and the second car to propagate communications signals between the first car and the second car.

36. A system for establishing intra-train communications between two or more cars of a train comprising:
a first terminal in a first car of a train, wherein the first terminal is associated with a unique identifier;
a second terminal in a second car of the train;
a first wired communications link between the first terminal and the second terminal; and
a wireless communications link between the first terminal and the second terminal;
wherein the wireless communications link between the first terminal and the second terminal is established based upon a communication of the unique identifier from the first terminal to the second terminal using the first wired communications link.

37. The system of claim 36, wherein the first wired communications link comprises an audio communications link connecting a first audio system in the first car with a second audio system in the second car.

38. The system of claim 36, wherein the first terminal is configured to establish the wireless communications link with the second terminal upon verifying an identifier communicated by the second terminal to the first terminal using the first wired communications link.

39. The system of claim 36, wherein the second terminal is associated with a second unique identifier, each of the first terminal and the second terminal are configurable as a master terminal, based upon a result of a challenge routine one of the first terminal and the second terminal is configured as a master terminal, and the wireless communications link between the first terminal and the second terminal is established based upon the unique identifier associated with the terminal configured as the master terminal.

40. A first terminal for use in a train consist comprising:
a first communications port configured for use in establishing an electrical communications signal connection between the first terminal and a second terminal;
a second communications port configured for use in establishing a wireless communications signal connection between the first terminal and the second terminal;
a data storage device, configured to store one or more operational parameters associated with the wireless communications signal connection; and
a processor configured to output for communication to the second terminal through the first communications port, at least one of the one or more operational parameters associated with the wireless communications signal connection.

41. The terminal of claim 40, wherein the first communications port is configured to output one or more electrical communications signals to the second terminal utilizing a power line based communications protocol.

42. The terminal of claim 41, wherein the power line based communications protocol is LonTalk compliant.

43. The terminal of claim 40, wherein the first communications port is connected to an intra-train audio communications link, and the electrical communications signal connection between the first terminal and the second terminal utilizes the audio communications link.

44. The terminal of claim 40, wherein at least one of the one or more operational parameters includes a service set identifier.

45. The terminal of claim 40, wherein at least one of the one or more operational parameters includes a listing of one or more media access control identifiers.

46. The terminal of claim 45, wherein the data storage device stores a computer-executable code that, when executed by the processor, causes the terminal to perform the operations of:
receiving an identification of a media access control identifier from the second terminal;
determining whether the received media access control identifier is listed on the listing of one or more media access control identifiers; and when the received media access control identifier is listed,
communicating, using the first communications port, at least one parameter required to establish a wireless communications connection between the first terminal and the second terminal.

47. The terminal of claim 46 wherein the at least one parameter communicated includes a service set identifier and a password.
